(19) United States
(12) Patent Application Publication
(10) Pub. No.: US 2007/0264451 A1
(43) Pub. Date: Nov. 15, 2007

(54) Method of manufacturing polymer member and polymer member

(75) Inventors: Atsushi Yusa, Ibaraki-shi (JP); Yoshiyuki Nomura, Ibaraki-shi (JP); Tetsuo Mizumura, Ibaraki-shi (JP); Hideo Daimon, Ibaraki-shi (JP)

Correspondence Address: OLIFF & BERRIDGE, PLC, P.O. BOX 19928, ALEXANDRIA, VA, 22320, US

(73) Assignee: HITACHI MAXELL, LTD., IBARAKI-SHI (JP)

(21) Appl. No.: 11/797,852

(22) Filed: May 8, 2007

(30) Foreign Application Priority Data
May 11, 2006 (JP) 2006-132246
Sep. 28, 2006 (JP) 2006-263976
Dec. 7, 2006 (JP) 2006-330167

(51) Int. Cl. B05D 3/10; B05D 1/36; B05D 1/18; B31B 45/00; B32B 3/00; B32B 3/26; B32B 15/04

(52) U.S. Cl. 428/34.1; 427/404; 427/443.1; 427/336; 428/304.4; 428/457; 428/156

(57) ABSTRACT

An electroless plating film with high adhesive strength is formed on surfaces of polymer substrates of various kinds, at low cost by providing a method of manufacturing a polymer member, including: preparing a polymer substrate having metallic fine particles impregnated on and inside a surface thereof; bringing pressurized carbon dioxide into contact with the polymer substrate to swell a surface area of the polymer substrate; and bringing an electroless plating solution containing pressurized carbon dioxide and being in a state causing a plating reaction, into contact with the polymer substrate while the surface area of the polymer substrate is swollen, to form a plating film on the polymer substrate.

### BACKGROUND OF THE INVENTION

1. Field of the Invention

The present invention relates to a polymer member in which a plating film is formed on a plastic polymer substrate and a method of manufacturing thereof.

2. Description of the Related Art

As a method of forming a metal film on a surface of a polymer substrate (polymer molded article) at low cost, an electroless plating method has been conventionally known. However, in the electroless plating method, in order to ensure adhesion of the plating film, etching a surface of the polymer substrate with an oxidizer having a high environmental burden such as hexavalent chromic acid or permanganic acid to roughen the surface of the polymer substrate is required as pretreatment of the electroless plating. Further, a polymer immersed by an etching solution, that is, a polymer to which the electroless plating is applicable has been limited only to a polymer such as ABS. This is because ABS contains a butadiene rubber component and the etching solution selectively immerses this component to form a rugged surface, but in other polymers, which little contain such a component selectively oxidized by the etching solution, it is difficult to form the rugged surface. Therefore, as for polycarbonate or the like which is a polymer other than ABS, plating grade in which ABS or elastomer is mixed so as to enable electroless plating is commercially available on the market. However, in such a polymer of the plating grade, deterioration in physical property such as deterioration in heat resistance of a main material cannot be avoided and therefore the application of such a polymer to a molded article requiring heat resistance has been difficult.

Further, there has conventionally been proposed a technique of applying a surface modification method using pressurized carbon dioxide such as supercritical carbon dioxide to the plating pretreatment. In the surface modification method using pressurized carbon dioxide, a functional material is dissolved in the pressurized carbon dioxide, and the pressurized carbon dioxide in which the functional material is dissolved is brought into contact with a polymer substrate, thereby impregnating the functional material on and inside a surface of the polymer substrate to highly functionalize (modify) the surface of the polymer substrate. For example, the present inventors disclosed, in Japanese Patent Publication No. 3696878, a method of highly functionalizing a surface of a polymer molded article by performing surface modification treatment using pressurized carbon dioxide simultaneously with injection molding.

Japanese Patent Publication No. 3696878 discloses the following surface modification method. First, after resin is platicized and measured in a heating (platicizing) cylinder of an injection molding machine, a screw in the heating cylinder is performed a suck-back process to be moved back. Next, pressurized carbon dioxide in a super critical state and a functional organic material such as a metal complex dissolved in the pressurized carbon dioxide are introduced into a screw front portion (flow front portion) of the molten resin in which a negative-pressure has arise (in which pressure has been decreased) by the suck-back of the screw. By this operation, the pressurized carbon dioxide and the functional material can be impregnated into the molten resin at the screw front portion. Next, the molten metal is filled in a mold by injection. At this time, the molten resin at the screw front portion into which the functional material has been impregnated is first injected to the mold, and then the molten resin in which little functional material has been impregnated is filled by injection. When the molten resin at the screw front portion into which the functional material has permeated is injected, the molten resin at the screw front portion comes into contact with the mold to form a surface layer (skin layer) while being attracted to a surface of the mold by a fountain flow phenomenon (fountain effect) of the flowing resin in the mold. Therefore, the surface modification method described in Japanese Patent Publication No 3696878 produces a polymer molded article in which the functional material is impregnated on and inside the surface thereof (whose surface is modified by the functional material). When the metal complex or the like containing metallic fine particles serving as plating catalysts is used as the functional material, a polymer molded article in which the plating catalysts are impregnated on and inside the surface thereof, which makes it possible to obtain an injection molded article to which electroless plating is applicable without any need for roughening its surface with an etching solution as has been done in the conventional plating pretreatment method.

Further, electroless plating methods using an electroless plating solution containing supercritical carbon dioxide are disclosed in, for example, Japanese Patent Publication No. 3571627, “Surface Technology” (Vol. 56, No. 2, page 83, 2005), and so on. These documents disclose the electroless plating methods in which the electroless plating solution and the supercritical carbon dioxide are mixed with each other by using a surfactant and generate an emulsion (emulsified state) by stirring, and a plating reaction is caused in the emulsion. Generally, in electrolytic plating and electroless plating, hydrogen gas generated during the plating reaction stays on a surface of an object to be plated, which will be a cause of the occurrence of pinholes in a plating film. However, in a case where the electroless plating solution containing the supercritical carbon dioxide is used as in the electroless plating methods disclosed in the documents as described above, the hydrogen generated during the plating reaction is removed because of solubility of hydrogen in the supercritical carbon dioxide. As a result, it is seen that the occurrence of the pinholes difficult, and an electroless plating film with high hardness is obtained.

Further, as the electoless plating method other than the electroless plating method using supercritical carbon dioxide, an electroless plating, which is applied, to an insulative material, by a buildup method using a photocatalyst has been conventionally proposed in, for example, “Surface Technology” (Vol. 57. No. 2, pages 49-53, 2006). In the proposed technique described in this document, a metal film is formed on a surface of an epoxy resin insulation material in a state that a copper plating film penetrates into a modified layer (with a thickness in a range of about 30 to 50 nm) formed on the surface of the epoxy resin insulation material.

The conventional methods of plating a polymer substrate using the etching solution in the plating pretreatment as described above require the pretreatment having a high environmental burden and have narrow selectivity of the polymer material.

Further, in a case where the metallic fine particles serving as the plating catalysts are impregnated on and inside the surface of the polymer substrate by using the surface modification method of the polymer substrate using pressurized carbon dioxide such as a supercritical fluid as described in Japanese Patent Publication No. 3696878, a polymer substrate on whose surface and in the inside of whose surface the metallic fine particles serving as the plating catalysts exist is obtained as described above. However, in a case that the electroless plating is performed to such a polymer substrate, only the metallic fine particles existing in the uppermost surface of the polymer substrate contribute as catalyst cores of the electroless plating, and the metallic fine particles existing in the inside (on and inside the surface) of the polymer substrate become useless catalyst cores, which is economically inefficient. Further, in a case where a plating film is formed on the polymer substrate obtained by using the technique described in Japanese Patent Publication No. 3696878, a physical anchor effect of the plating film is difficult to obtain since the surface of the polymer substrate is not roughened. Therefore, the method has posed a problem that tight or strong adhesion between the plating film and the molded article is difficult to obtain.

### SUMMARY OF THE INVENTION

The present invention was made to solve the above-described problems and it is an object of the present invention to provide a method of manufacturing a polymer member capable of forming, at low cost, an electroless plating film with high adhesive strength on a surface of a polymer substrate. It is another object of the present invention to provide a polymer member in which an electroless plating film with high adhesive strength is formed on a polymer substrate.

According to a first aspect of the present invention, there is provided a method of manufacturing a polymer member, comprising:

preparing a polymer substrate having metallic fine particles impregnated on and inside a surface thereof;

bringing pressurized carbon dioxide into contact with the polymer substrate to swell a surface area of the polymer substrate; and

bringing an electroless plating solution containing the pressurized carbon dioxide into contact with the polymer substrate, in a state that the surface area of the polymer substrate is swollen, to form a plating film on the polymer substrate.

Note that “pressurized carbon dioxide” in this description means carbon dioxide that is pressurized. In addition, note that “pressurized carbon dioxide” in this description includes not only carbon dioxide in a supercritical state but also pressurized liquid carbon dioxide and pressurized carbon dioxide gas. Further, note that, in terms of the pressure, the pressurized carbon dioxide includes not only carbon dioxide pressurized to a pressure equal to or higher than a critical point (supercritical state) but also carbon dioxide pressurized to a pressure lower than the critical point.

In the present invention, in order to easily mix the electroless plating solution and the pressurized carbon dioxide, pressurized carbon dioxide having a temperature and a pressure under which the density of the carbon dioxide fall within the following range, may be used. A preferable range of the density of the pressurized carbon dioxide is from 0.10 g/cm³ to 0.99 g/cm³, more preferably, from 0.40 g/cm³ to 0.99 g/cm³. When the density of the pressurized carbon dioxide is lower than this range, its compatibility with the electroless plating solution decreases and its permeability into the polymer substrate also decreases. On the other hand, when the density of the pressurized carbon dioxide is higher than the above range, the pressure of the pressurized carbon dioxide becomes very high (for example, the pressure becomes 30 MPa or higher at 10° C. temperature, and the pressure becomes 40 MPa or higher at 20° C. temperature), and therefore, a mass production apparatus becomes expensive.

To obtain the above density of the pressurized carbon dioxide, the temperature of the carbon dioxide may be set to a temperature in range of 10° C. to 110° C., and the pressure thereof may be set to a pressure in a range of 5 MPa to 25 MPa. In particular, the pressurized carbon dioxide may be supercritical carbon dioxide whose temperature is 31° C. or higher and whose pressure is 7.38 MPa or higher. When the pressurized carbon dioxide changes to the supercritical state, not only the density of the pressurized carbon dioxide becomes high but also surface tension becomes zero, and consequently permeability of the plating solution into the polymer substrate is improved. However, when the temperature is 10° C. or lower, a plating reaction is difficult to occur, and when the temperature is 110° C. or higher, a negative effect such as the decomposition of the plating solution occurs. As for the pressure, when the pressure is 5 MPa or lower, the density of the carbon dioxide greatly decreases, and when the pressure is 25 MPa or higher, a load of an apparatus for industrial production increases.

Note that “electroless plating method” in this description means a method of depositing a metal-coating film on a substrate surface having catalytic activity by using a reducing agent, without using an external power source. Further, note that “surface area” of the polymer substrate includes not only the surface of the polymer substrate but also an area which is located adjacent to the surface of the polymer substrate in a thickness direction (depth direction) of the polymer substrate.

The present inventors performed a diligent investigation in relation to the electroless plating methods using an electroless plating solution containing supercritical carbon dioxide, as disclosed in the Japanese Patent Publication No. 3571627, “Surface Technology” (Vol. 56, No. 2, page 83, 2005), and so on. As a result, it has been found out that, when a polymer substrate in which the metallic fine particles are impregnated on and inside the surface thereof (polymer substrate containing the metallic fine particles in its surface and an area which is located adjacent to the surface) is simply brought into contact with an electroless plating solution (electroless plating solution in a state causing a plating reaction) containing pressurized carbon dioxide, an electroless plating film is formed on the surface of the polymer substrate but it is difficult to form a plating film having sufficient adhesion. According to verifying experiments by the present inventors, it has been found out that in this case, a physical anchor effect of the plating film is difficult to obtain because the metallic fine particles existing on the uppermost surface of the polymer substrate mainly serve as catalyst cores for the growth of the plating film (almost no plating film grows in the inside of the polymer substrate). This is thought to be a reason why it was not possible to obtain tight adhesion between the plating film and the molded article when the electroless plating solution in the state causing the plating reaction, together with the pressurized carbon dioxide, is simply brought into contact with the polymer substrate.

On the other hand, in the method of manufacturing the polymer member of the present invention, the polymer substrate in which the metallic fine particles (metal substances) such as Pd, Ni, Pt, or Cu which serve as plating catalyst cores are impregnated on and inside the surface thereof is first prepared, and next, the pressurized carbon dioxide is brought into contact with the polymer substrate. At this time, in a case that the polymer substrate is formed of an amorphous material, the glass transition temperature lowers and the surface area softens to be swollen. In a case that the polymer substrate is formed of a crystalline material, although the surface area does not soften, the surface area is swollen since an intermolecular distance increases in the surface area.

Next, the electroless plating solution (electroless plating solution in a state causing the plating reaction (for example, in a high-temperature state)) containing the pressurized carbon dioxide is brought into contact with the polymer substrate having such a surface state. At this time, since the electroless plating solution is brought into contact with the polymer substrate in which the surface area of the polymer substrate is in the swollen state, it is possible for the electroless plating solution together with the pressurized carbon dioxide to permeate into the inside or inner part of the polymer substrate. Further, at this time, since surface tension of the electroless plating solution in which the pressurized carbon dioxide in the supercritical state or the like is mixed becomes lower, the electroless plating solution can more easily permeate into the inside of the polymer substrate. As a result, the electroless plating solution reaches the metallic fine particles existing in the inside of the polymer substrate, and the plating film grows from the metallic fine particles serving as the catalyst cores. That is, in the method of forming the plating film of the present invention, since the plating film not only grows on the surface of the polymer substrate but also grows from the metallic fine particles existing in the inside serving as the catalyst cores, the plating film is formed continuously from the inside to the surface of the polymer substrate (the plating film is formed on the polymer substrate in a state that part of the plating film penetrates in the inside of the polymer substrate). Therefore, in the method of manufacturing the polymer member of the present invention, it is possible to easily form the plating film with excellent adhesion on any of various kinds of polymer substrates without any need for roughening the surface of the polymer substrate by etching, as has been done in the conventional electroless plating methods. Further, in the method of manufacturing the polymer member of the present invention, since the surface of the polymer member is not roughed as has been done in the conventional electroless plating methods, it is possible to form the plating film with extremely small (nano-order) surface roughness.

In addition, in the method of manufacturing the polymer member of the present invention, when the electroless plating solution containing the pressurized carbon dioxide is brought into contact with the polymer substrate, the electroless plating solution can permeate up to a deeper position in the inside of the polymer substrate because the pressurized carbon dioxide has diffusibility equivalent to that of gas, which makes it possible to form the plating film continuously from a deeper position. For example, it is possible to form the plating film continuously from a micron-order depth (part of the plating film can penetrate up to a micron-order depth). Incidentally, by the electroless plating method disclosed in the above “Surface Technology” (Vol. 57, No. 2, pages 49-53, 2006), it is also possible to form a plating film continuously from the inside of the polymer substrate but this method is a method of giving a hydrophilic property (wettability) to the uppermost surface layer portion of the polymer substrate by a photocatalytic effect and growing the plating film on this surface-modified uppermost surface layer, and therefore, the penetration depth of the plating film is about several tens nm, and it is difficult to manufacture a polymer member in which part of the plating film penetrates up to a micron-order depth as in the present invention.

In the method of manufacturing the polymer member of the present invention, when the pressurized carbon dioxide is brought into contact with the polymer substrate, the electroless plating solution having a temperature not causing a plating reaction together with the pressurized carbon dioxide may be brought into contact with the polymer substrate to be impregnated into the polymer substrate, and when the plating film is formed on the polymer substrate, the temperature of the electroless plating solution may be increased to a temperature causing the plating reaction. In this method, before the plating reaction is caused, the electroless plating solution not in the plating reaction state together with the pressurized carbon dioxide is brought into contact with the polymer substrate. Consequently, it is possible to swell the polymer substrate and at the same time to impregnate the electroless plating solution into the inside of the polymer substrate. Therefore, in this method, the electroless plating solution can surely impregnate into a deeper position, which makes it possible to stably form a closely-attached metal film having high adhesion on the surface of the polymer substrate.

In the method of manufacturing the polymer member of the present invention, the electroless plating solution may contain alcohol.

According to investigations performed by the present inventors, it has been found out that in the electroless plating methods using the electroless plating solution containing supercritical carbon dioxide, as disclosed in the above Japanese Patent Publication No. 3571627, “Surface Technology” (Vol. 56, No. 2, page 83, 2005), and soon, the carbon dioxide in a high-pressure state and the electroless plating solution as a water solution are not easily mixed with each other even by using a surfactant, and therefore a stirring effect needs to be improved. Specifically, it has been found out that the use of a stirrer with a high stirring torque or the use of a high-pressure container with a shallow bottom is necessary. That is, it has been found out that, in order to uniformly mix the electroless plating solution and the pressurized carbon dioxide to obtain a stable emulsion, there is a great restriction in the shape of the high-pressure container or the stirrer and the rotation speed of the stirrer.

Therefore, the present inventors repeated investigations in order to solve this problem. As a result, it has been found out that, although a main component of the electroless plating solution is water, by further mixing alcohol to the electroless plating solution, the carbon dioxide in the high pressure state and the plating solution are easily and stably mixed with each other even when the electroless plating solution and the pressurized carbon dioxide are not stirred. A possible reason for this is that alcohol is easily mixed with carbon dioxide in the high-pressure state. Therefore, when an electroless plating solution is prepared, a concentrate solution containing metal ions, a reducing agent, and so on is usually diluted with water according to, for example, a component ratio recommended by a maker, thereby making up a bath of a plating solution, but in the method of manufacturing the polymer member of the present invention, only by further mixing alcohol at an arbitrary ratio in water, it is possible to prepare a stable electroless plating solution in which the pressurized carbon dioxide is uniformly mixed. A volume ratio of water and alcohol (alcohol/water) may be any, but it is desirable that the ratio falls within a range from 10 to 80%. When a ratio of alcohol is low, a stable mixed solution is difficult to obtain. On the other hand, when a ratio of alcohol is too high, a bath is not sometimes stabilized because an organic solvent such as ethanol is insoluble in, for example, nickel sulfate used in nickel-phosphorus plating.

The kind of alcohol usable in the present invention may be any, and methanol, ethanol, n-propanol, isopropanol, butanol, heptanol, ethylene glycol, or the like is usable.

Further, in the method of manufacturing the polymer member of the present invention, in a case that alcohol is added to the electroless plating solution, surface tension of the electroless plating solution to which alcohol is added greatly decreases because alcohol is lower in surface tension than water. Therefore, the electroless plating solution more easily permeates into a free volume (inside or inner part) of the polymer substrate (and voids, areas impregnated with a dissolution substance, and soon in the polymer substrate, which will be described later).

In the method of manufacturing the polymer member of the present invention, the electroless plating solution may contain a surfactant. In this case, it is possible to further improve compatibility (affinity) between the pressurized carbon dioxide such as supercritical carbon dioxide and the electroless plating solution as a water solution to promote the formation of the emulsion. It is also possible to improve affinity of the plating solution with the polymer substrate.

As the surfactant, at least one kind or more of surfactants may be selected and used from among generally known nonionic, anionic, cationic, and ampholyte-ionic surfactants. In particular, various kinds of surfactants which have been confirmed as effective for forming an emulsion of supercritical carbon dioxide and water are usable. For example, block copolymer of polyethylenoxide (PEO)-polypropyleneoxide (PPO), ammonium carboxylate perfluoropolyether (PFPE), block copolymer of PEO-polybutyleneoxide (PBO), octaethyleneglycol monododecyl ether, or the like is usable.

In the method of manufacturing the polymer member of the present invention, the pressurized carbon dioxide may be supercritical carbon dioxide having a pressure in a range of 7.38 MPa to 20 MPa. A critical pressure of carbon dioxide is 7.38 MPa, and in a supercritical state at the critical pressure or higher, carbon dioxide comes to have a high density and is easily mixed with the plating solution, which is preferable. The pressure equal to or higher than 30 MPa causes problems such as an excessive increase in a usage amount of the carbon dioxide or difficulty in sealing a high-pressure container and thus is not desirable.

The method of manufacturing the polymer member of the present invention may further include performing at least one of electroless plating and electrolytic plating at atmospheric pressure after forming the plating film on the polymer substrate.

In the method of manufacturing the polymer member of the present invention, to ensure adhesion between the plating film and the polymer substrate, a plating film with the minimum thickness may be formed on the surface of the polymer substrate in a short time. Consequently, it is possible to inhibit excessive permeation of the electroless plating solution into the inside of the polymer substrate, which in turn can inhibit deformation and quality deterioration of the polymer substrate due to the electroless plating solution. Further, in a case that the thickness of the plating film needs to be increased, by a conventional plating method (an electroless plating method and/or an electrolytic plating method) at atmospheric pressure after forming the electroless plating film on the polymer substrate by the above-described method of the present invention, it is possible to laminate a plating film with a desired thickness on the polymer substrate. According to this method, a plating film realizing both its reliability (adhesion) and the securing of its physicality such as conductivity can be obtained.

The method of manufacturing the polymer member of the present invention may further include performing black electroless plating after forming the plating film on the polymer substrate. In this case, a black electroless plating film is formed on the polymer substrate, and therefore, when this is applied to an inner wall of a camera module or the like, it is possible to obtain an electromagnetic wave shield effect while reducing ghost flare by light reflection.

In the method of manufacturing the polymer member of the present invention, the preparing of the polymer substrate having the metallic fine particles impregnated on and inside the surface thereof may include bringing a pressurized fluid in which a metal complex containing the metallic fine particles is dissolved, into contact with the polymer substrate. Note that “pressurized fluid” in this description means a fluid that is pressurized, and includes not only a supercritical fluid but also a pressurized liquid-form fluid (liquid) and high-pressure gas such as pressurized inert gas. As the pressurized fluid, pressurized carbon dioxide is preferable, and in particular, supercritical carbon dioxide is preferable.

In the method of manufacturing the polymer member of the present invention, the preparing of the polymer substrate having the metallic fine particles impregnated on and inside the surface thereof may include molding the polymer substrate, which has the metallic fine particles impregnated on and inside the surface thereof, in a mold of an injection molding machine.

As a method of impregnating the metallic fine particles derived from the metal complex into the polymer substrate by using the injection molding machine, a method of impregnating the metallic fine particles into a flow front portion of molten resin as described in, for example, the above Japanese Patent Publication No. 3696878 may be used. In this method, it is possible not only to impregnate the metallic fine particles only into a surface area of a molded article at the time of injection molding but also to modify any of various materials simultaneously with the molding with little material loss. Further, in a case that, after the molding, a plating film is grown on a surface of the molded article by an electroless plating method in the same mold, a metal film with high adhesion can be formed simultaneously with the injection molding, and therefore, the polymer member can be manufactured at low cost. In addition, as a method of impregnating the metallic fine particles into the polymer by using the injection molding machine, a sandwich molding method may be used.

In the method of manufacturing the polymer member of the present invention, a method of impregnating the metallic fine particles into the inside of the polymer substrate may be any, and for example, a material in which the metallic fine particles and resin are blended may be mixed by extrusion molding to produce pellets. Resin dissolved in a solvent and the metallic fine particles may be mixed in a casting method. Alternatively, varnish of polyimide or the like in which the metallic fine particles are dispersed may be applied on a substrate such as a polyimide sheet to be cured.

In the method of manufacturing the polymer member of the present invention, when the plating film is formed on the polymer substrate, a high-pressure container made of metal and including, on an inner wall surface thereof, a film made of a material inert to the electroless plating solution can be used, and in the high-pressure container, the polymer substrate can be brought into contact with the electroless plating solution containing the pressurized carbon dioxide.

In a conventional electroless plating method, a resin container is generally used as a plating solution container, but in the plating methods using a plating solution containing pressurized carbon dioxide as described in, for example, the above Japanese Patent Publication No. 3571627, “Surface Technology” (Vol. 56, No. 2, page 83, 2005), and so on, it is necessary to cause a plating reaction in a high-pressure container, that is, a metal container requiring pressure resistance. However, according to verifying experiments performed by the present inventors, it has been found out that, in a case that a metal material such as SUS is used for the high-pressure container, plating bath becomes unstable because a plating film grows also on a surface of the high-pressure container which is not an object (polymer substrate) to be plated, and as a result, it becomes difficult to grow a uniform metal film on the object to be plated. It has been also found out that poor adhesion of the plating film growing on the surface of the container causes a problem that the plating film growing on the container surface peels off during the plating and the peeled plating film is mixed as a extraneous substance in the polymer member. That is, it has been found out that, in the plating method using the electroless plating solution containing the pressurized carbon dioxide, the metal high-pressure container is difficult to use as the container for the electroless plating in industrial production due to the above problems.

On the other hand, in the method of manufacturing the polymer member of the present invention, in a case that a plating reaction is caused in the high-pressure container made of metal and having on surface thereof the film inert to the electroless plating solution, that is, a film made of a material on which a plating film does not grow (hereinafter, also referred to as a plating ungrowable film), the above problems can be solved, and therefore, it is possible to easily form an emulsion of the electroless plating solution and the pressurized carbon dioxide to stabilize the plating reaction. Moreover, since the electroless plating solution is stabilized in the high-pressure container and the plating film stably grows on a material to be plated such as the polymer substrate, industrialization becomes possible.

In the method of manufacturing the polymer member of the present invention, the film may be formed of diamond-like carbon.

As a material forming the plating ungrowable film formed on the inner wall of the high-pressure container as described above, any material may be used provided that it is a material in which a plating film does not grow on a surface of the inner wall. For example, a dense carbon film of diamond-like carbon (hard carbon film) or the like or a thin film of an organic substance such as PTFE (polytetrafluoroethylene) or PEEK (polyetheretherketon) not easily damaged by supercritical carbon dioxide is usable. These thin films can be formed by using radio-frequency plasma CVD, sputtering, thermal spraying, painting, or the like. Alternatively, a stable metal film of gold (Au), titanium, or the like may be coated by plating or sputtering. In addition, any material is usable as a material of the high-pressure container made of metal in the present invention, but a material resistant to acid of the plating solution is usable. For example, SUS316, SUS316L, Hastelloy, titanium, Inconel, or the like is usable.

In the method of manufacturing the polymer member of the present invention, when the plating film is formed on the polymer substrate, a plating apparatus may be used, the plating apparatus including: a high-pressure container made of metal; and an inner container disposed in the high-pressure container and formed of a material inert to the electroless plating solution; and

in the inner container, the polymer substrate may be brought into contact with the electroless plating solution containing the pressurized carbon dioxide.

In a case that the plating apparatus is used which includes, in high-pressure container made of metal, the inner container made of a material inert to the electroless plating solution, that is, a material on which no plating film grows, for example, which includes a resin container, an emulsion of the pressurized carbon dioxide and the plating solution is formed only in the resin container where a stirring effect works. Therefore, the plating solution does not easily come into direct contact with an inner wall of the high-pressure container housing the inner container and thus the plating reaction occurs only in the inner container, which enables stable plating. Further, in this case, since there is no need for coating the inner wall of the high-pressure container, the apparatus costs low. Incidentally, since diffusibility of the electroless plating solution in which the pressurized carbon dioxide is dispersed is low, the electroless plating solution little leaks out of the inner container.

In the method of manufacturing the polymer member of the present invention, the inner container may be formed of polytetrafluoroethylene. Further, as a material forming the inner container other than polytetrafluoroethylene (PTFE), a resin material such as polyetheretherketon (PEEK) or polyimide, a material in which such a resin material and an inorganic substance such as glass fiber are mixed, or a metal material such as titanium, Hastelloy, or Inconel is usable.

In the method of manufacturing the polymer member of the present invention, when the polymer substrate is prepared, a polymer substrate having the metallic fine particles and particles of a substance soluble in the electroless plating impregnated on and inside the surface thereof may be prepared.

The following effects can be obtained when a polymer substrate having not only the metallic fine particles such as Pd, Ni, Pt, or Cu serving as plating catalyst cores but also the substance soluble in the electroless plating solution (hereinafter, referred to as a dissolution substance) which are impregnated on and inside the surface thereof, is prepared as the polymer substrate and the electroless plating solution containing the pressurized carbon dioxide is brought into contact with such a polymer substrate in a swollen state.

Firstly, the electroless plating solution together with the pressurized carbon dioxide permeates into the inside of the polymer substrate and the electroless plating solution reaches the metallic fine particles existing in the inside of the polymer substrate to grow a plating film from the metallic fine particles serving as the catalyst cores. As a result, since the plating film is formed continuously from the inside to the surface of the polymer substrate, it is possible to easily form a plating film excellent in adhesion on any of polymer substrates of various kinds, without any need for roughening the surface of the polymer substrate by etching, as has been done in the conventional electroless plating method.

Moreover, since the dissolution substance is impregnated on and inside the surface of the polymer substrate, the dissolution substance impregnating in the inside of the polymer substrate is dissolved in the electroless plating solution when the electroless plating solution containing the pressurized carbon dioxide is brought into contact with the polymer substrate, and the electroless plating solution enters an area which was occupied by the dissolution substance (the area impregnated with the dissolution substance is replaced by the electroless plating solution). As a result, the plating film grows also in the area entered by the electroless plating solution (area which was occupied by the dissolution substance). In this method, even in a case that a material such as a crystalline material whose internal free volume does not easily increase is used as the polymer substrate, a sufficient area (space) for the growth of the electroless plating film can be easily secured in the inside of the polymer substrate. Further, since the size of the area occupied by the dissolution substance can be controlled by a molecular weight of the dissolution substance, the size of fine plating particles growing in the area which was occupied by the dissolution substance (area replaced by the electroless plating solution) can also be arbitrarily controlled by the molecular weight of the dissolution substance. Therefore, in a case that the electroless plating film is formed on the polymer substrate in which the dissolution substance is impregnated together with the metallic fine particles, a plating film area having a complicated shape (a capillary shape, an ant-nest shape, a net shape, or the like) can be formed in the polymer substrate, which makes it possible to form a plating film having stronger adhesion than in a case that the dissolution substance is not impregnated.

In the method of manufacturing the polymer member of the present invention, the preparing of the polymer substrate having the metallic fine particles and the particles of the substance soluble in the electroless plating solution impregnated on and inside the surface thereof may include molding, in a mold of an injection molding machine, the polymer substrate having the metallic fine particles and the substance soluble in the electroless plating solution impregnated on and inside the surface thereof.

A method of impregnating the particles of the dissolution substance and the metallic fine particles derived from the metal complex into the polymer substrate by using the injection molding machine may be any. For example, a method of impregnating the metallic fine particles and the dissolution substance into a flow front portion of molten resin may be used. Further, as a method of impregnating the metallic fine particles and the particles of the dissolution substance into the polymer substrate by using the injection molding machine, a sandwich molding method may be used. Further, a material in which the metallic fine particles and the dissolution substance are blended with resin may be mixed by extrusion molding to produce pellets. Resin dissolved in a solvent may be mixed with the metallic fine particles and the dissolution substance in a casting method. Further, varnish of polyimide or the like in which the metallic fine particles and the dissolution substance are dispersed may be applied on a substrate such as a polyimide sheet or the like to be cured.

In the method of manufacturing the polymer member of the present invention, the substance soluble in the electroless plating solution can be a water soluble substance.

As the substance soluble in the electroless plating solution (dissolution substance), any material is usable provided that it is a material soluble in the electroless plating solution whose major components are water and alcohol, and in particular, a water soluble substance or a soluble low-molecular substance is suitable. As the water soluble substance, for example, a mineral component such as calcium oxide or magnesium oxide, polyalkyl glycol, or the like is usable. Further, as the soluble low-molecular substance, for example, ε-caprolactam, polyalkyl glycol such as polyethylene glycol, or the like is usable. In addition, the size of the particles of the dissolution substance impregnated into the polymer substrate is appropriately adjustable by a molecular weight of the substance soluble in the electroless plating solution, and a preferably particle size is about 10 nm to 1 μm. The reason for this is that, when the particle size is smaller than 10 nm, the anchor effect of the plating film cannot be sufficiently obtained, and when the particle size is larger than 1 μm, the surface of the polymer member is excessively roughened and thus it is feared that metallic luster cannot be obtained on the plating film.

In the method of manufacturing the polymer member of the present invention, when the polymer substrate is prepared, a polymer substrate having the metallic fine particles and voids on and inside the surface thereof may be prepared.

In a case that the polymer substrate having the metallic fine particles and the voids on and inside the surface thereof is prepared and the electroless plating solution containing the pressurized carbon dioxide is brought into contact with such a polymer substrate in the swollen state, the electroless plating solution together with the pressurized carbon dioxide permeates into the inside of the polymer substrate and the electroless plating solution reaches the metallic fine particles existing in the inside of the polymer substrate, and consequently, a plating film grows from the metallic fine particles serving as catalyst cores. As a result, it is possible to easily form a plating film excellent in adhesion on any of polymer substrates of various kinds without any need for roughening the surface of the polymer substrate by etching as has been done in the conventional electroless plating method.

Further, in the case that the polymer substrate having the metallic fine particles and the voids on and inside the surface is prepared, when the electroless plating solution containing the pressurized carbon dioxide is brought into contact with the polymer substrate, the electroless plating solution enters the voids and a plating film grows also in the voids. Therefore, even in a case that a material such as a crystalline material whose internal free volume does not easily increase is used as the polymer substrate, an area (space) for the growth of the electroless plating film can be easily secured in the inside of the polymer substrate.

In the method of manufacturing the polymer member of the present invention, the preparing of the polymer substrate having the metallic fine particles and the voids on and inside the surface thereof may include: introducing, by using an injection molding machine which includes a mold and a heating cylinder, the pressurized carbon dioxide, in which a metal complex containing the metallic fine particles is dissolved, into molten resin of the polymer substrate in the heating cylinder; injecting, into the mold, the molten resin containing the introduced pressurized carbon dioxide in which the metal complex is dissolved; and forming the voids by foaming the pressurized carbon dioxide in the injected molten resin.

According to investigations performed by the present inventors, it has been found out that in the plating methods using the plating solution containing the pressurized carbon dioxide as described in the above Japanese Patent Publication No. 3571627, “Surface Technology” (Vol. 56, No. 2, page 83, 2005), and so on, when the pressurized carbon dioxide is mixed, a problem such as decrease in deposition rate of the electroless plating occurs depending on the mixing condition. A possible reason for this is that since the acidic pressurized carbon dioxide with high density is mixed in the electroless plating solution, pH (hydrogen ion exponent) of the electroless plating solution lowers and pH of a plating bath in which the pressurized carbon dioxide is mixed becomes lower than a lower limit value of an optimum pH range. Therefore, in the method of manufacturing the polymer member of the present invention, pH of the electroless plating solution may be adjusted to a high value in advance. In this case, when the electroless plating solution containing the high-density carbon dioxide is prepared, the mixed high-density carbon dioxide lowers pH of the electroless plating solution, so that pH of the plating bath can fall within the optimum pH range. Therefore, the use of this method can prevent the problem such as the decrease in the deposition rate of the plating film as described above.

In the method of manufacturing the polymer member of the present invention, as metal to be the plating coating film, Ni, Co, Pd, Cu, Ag, Au, Pt, Sn, or the like is usable, and they are supplied from metallic salts of nickel sulfate, palladium chloride, copper sulfate, and soon in the electroless plating solution. As a reducing agent, dimethylamine borane, sodium hypophosphite (sodium phosphinate), hydrazine, formalin, sodium boron hydroxide, potassium boron hydroxide, titanium trichloride, or the like is usable.

Further, any of well known additives of various kinds may be added to the electroless plating solution. For example, a complexing agent, such as citric acid, acetic acid, succinic acid, or lactic acid, which forms a stable soluble complex with metallic ions in the electroless plating solution may be added. As a stabilizer of the electroless plating solution, a sulfur compound such as thiourea, lead ions, a brightener, a wetting agent (surfactant), and the like may be added.

As a material forming the polymer substrate, any material is usable in the method of manufacturing the polymer member of the present invention, and thermoplastic resin, thermosetting resin, or ultraviolet curing resin is usable. In particular, a polymer substrate formed of thermoplastic resin is desirable. The kind of the thermoplastic resin may be any, and either of amorphous resin and crystalline resin can be applied. For example, synthetic fiber of polyester or the like, polypropylene, polyamide resin, polymethyl methacrylate, polycarbonate, amorphous polyolefin, polyetherimide, polyethylene telephthalate, liquid crystal polymer, ABS resin, polyamide-imide, polyphthalamide, polyphenylene sulfide, biodegradable plastic such as polylactic acid, nylon resin, etc. or a composite material of these is usable. Also a resin material in which various kinds of inorganic fillers and the like such as glass fiber, carbon fiber, nanocarbon, and mineral are kneaded is usable.

In the method of manufacturing the polymer member of the present invention, the shape and producing method of the polymer substrate may be any, and it is possible to use, for example, a sheet or a pipe produced by extrusion molding or a polymer molded article produced by ultraviolet curing or injection molding. Considering industrial production, it is preferable to use a polymer molded article obtained by injection molding which has high continuous productivity.

According to a second aspect of the present invention, there is provided a high-pressure container which is used in the method of manufacturing the polymer member as defined in the first aspect when the electroless plating solution is brought into contact with the polymer substrate, the high-pressure container including:

a high-pressure container body made of metal; and

a film formed on an inner wall surface of the high-pressure container body and formed of a material inert to the electroless plating solution.

In the high-pressure container of the present invention, the film may be formed of diamond-like carbon.

According to a third aspect of the present invention, there is provided a plating apparatus used in the method of manufacturing the polymer member as defined in the first aspect, the apparatus including:

a high-pressure container made of metal; and

an inner container disposed in the high-pressure container and used to bring the electroless plating solution into contact with the polymer substrate,

wherein the inner container is formed of a material inert to the electroless plating solution.

In the plating apparatus of the present invention, the inner container may be formed of polytetrafluoroethylene.

According to a fourth aspect of the present invention, there is provided a polymer member including:

a polymer substrate having metallic fine particles impregnated into a first area from a surface thereof to a predetermined depth; and

a metal film formed on the surface of the polymer substrate,

wherein a part of the metal film penetrates into a second area from the surface of the polymer substrate to a depth smaller than the predetermined depth.

Note that “predetermined depth” in which the metallic fine particles are impregnated, in this description, means a depth of 1 μm or more. Further, note that “depth smaller than the predetermined depth” into which a part of the metal film penetrates means a 100 nm depth or more from the surface of the polymer substrate and a position shallower than the predetermined depth in which the metallic fine particles are impregnated (hereinafter, this depth will be referred to as penetration depth of the metal film).

In the polymer member manufactured by the electroless plating methods disclosed in the above Japanese Patent Publication No. 3571627, “Surface Technology” (Vol. 56, No. 2, page 83, 2005), and so on, since the metallic fine particles existing in the uppermost surface of the polymer substrate serve as catalyst cores for the growth of the metal film as described above, the metal film little grows in the inside of the polymer substrate (a part of the metal film little penetrates into the polymer substrate). Further, in the polymer member manufactured by the electroless plating method disclosed in the above “Surface Technology” (Vol. 57, No. 2, pages 49-53, 2006), the penetration depth of the metal film is a depth in range of about 30 to 80 nm. On the other hand, in the polymer member of the present invention, a part of the metal film grows continuously from the surface to a deeper position of the polymer substrate as compared to the technology described in the above documents, that is, since a part of the metal film penetrates into a deeper position in the inner part of the polymer substrate, a higher anchor effect can be obtained and consequently, a polymer substrate including a metal film having higher adhesive strength can be obtained. Incidentally, the penetration depth and concentration distribution of the metallic fine particles vary depending on the material of the polymer substrate, process conditions, and so on.

In the polymer member of the present invention, particles of a substance soluble in the electroless plating solution may exist in an inside of the polymer substrate. Further, the substance soluble in the electroless plating solution may be a water soluble material

In the polymer member of the present invention, voids may exist in an inside of the polymer member. Note that “void” in this description means a void having a size in a range of about 10 nm to 100 μm. Such the voids can be formed by, for example, foaming the pressurized carbon dioxide which has been impregnated into the polymer member. In addition, when the void is smaller than 10 nm, cell (void) density decreases to reduce the anchor effect of the plating film, and when the void is larger than 100 μm, there is a fear that mechanical physicality and flatness of the surface of the polymer member greatly deteriorate. The size of the void is appropriately adjustable by a method of changing the pressure during the molded resin is filled in the mold, a core back method of the mold, or the like, when the polymer member is molded.

According to the method of manufacturing the polymer member of the present invention, since the plating film growing not only on the surface of the polymer substrate but also from the inside thereof can be formed on the polymer substrate, a plating film with excellent adhesion can be formed.

According to the method of manufacturing the polymer member of the present invention, since the plating reaction is caused by impregnating the electroless plating solution into the inside the polymer substrate, roughening the surface of the polymer substrate as has been conventionally done is not necessary, and it is possible to form a plating film with excellent adhesion on any of various polymer substrates.

In the method of manufacturing the polymer member of the present invention, in a case that alcohol is further mixed in the electroless plating solution, it is possible to improve compatibility (affinity) between the electroless plating solution and the carbon dioxide.

In the method of manufacturing the polymer member of the present invention, in a case that the high-pressure container made of metal and having the plating ungrowable film on the inner wall surface thereof, the inner container made of resin, or the like is used and the plating film is formed in this container, it is possible to inhibit the growth of the plating film on places other than an object to be plated (polymer member), which makes it possible to stabilize the plating reaction in the container. Therefore, cyclic stability of the plating film formation is improved, which enables industrialization.

In the method of manufacturing the polymer member of the present invention, in a case that the polymer substrate having not only the metallic fine particles but also the dissolution substance or the voids on and inside the surface thereof is used, it is possible to grown the plating film by impregnating the electroless plating solution into the area which was occupied by the dissolution substrate impregnating in the inside of the polymer substrate or into the voids, and therefore, even in a case that a material such as a crystalline material whose internal free volume does not easily increase is used for the polymer substrate, the area (space) for the growth of the electroless plating film can be easily secured in the inner part of the polymer substrate.

In the method of manufacturing the polymer member of the present invention, in a case that the polymer substrate having not only the metallic fine particles but also the dissolution substance or the voids on and inside the surface thereof is used, the plating film grows in the area which was occupied by the dissolution substance impregnating in the inside of the polymer substrate or in the voids, and therefore, a plating film area with a complicated shape can be formed in the inside of the polymer substrate, which makes it possible to form a plating film with more stronger adhesion.

According to the polymer member of the present invention, since a part of the metal film formed on the polymer substrate penetrates on and inside the surface of the polymer substrate, a polymer member having the metal film with more excellent adhesion can be obtained.

According to a fifth aspect of the present invention, there is provided a method of manufacturing a polymer member, including:

preparing a polymer member in whose surface metallic fine particles serving as catalyst cores of electroless plating exist;

holding the prepared polymer member in a mold;

providing a gap between a part of the surface of the polymer member and a surface of the mold facing to the surface of the polymer member;

introducing, in the gap, a mixed fluid containing pressurized carbon dioxide, a surfactant, and an electroless plating solution to bring the mixed fluid into contact with the surface of the polymer member defining the gap, thereby forming a plating film on the surface of the polymer member defining the gap.

In the method of manufacturing the polymer member according to the fifth aspect of the present invention, the polymer member in whose surface metallic fine particles serving as catalyst cores of electroless plating exist may be manufactured by a method including: dissolving the metallic fine particles in the pressurized carbon dioxide; and bringing the pressurized carbon dioxide in which the metallic fine particles are dissolved, into contact with the polymer member.

The method of manufacturing the polymer member according to the fifth aspect of the present invention may further include forming a silver reflection film by a silver mirror reaction (electroless silver plating), on the plating film formed on the polymer member.

In the method of manufacturing the polymer member according to the fifth aspect of the present invention, the polymer member may be a metal reflector.

According to a sixth aspect of the present invention, there is provided a method of forming a plating film on a polymer substrate, including:

holding, in a mold, a polymer substrate in whose surface metallic fine particles serving as catalyst cores of electroless plating exist;

providing a gap between a part of the surface of the polymer substrate and a surface of the mold facing to the surface, of the polymer substrate; and

introducing, in the gap, a mixed fluid containing pressurized carbon dioxide, a surfactant, and an electroless plating solution to bring the mixed fluid into contact with the surface of the polymer substrate defining the gap, thereby forming a plating film on the surface of the polymer substrate defining the gap.

### BRIEF DESCRIPTION OF THE DRAWINGS

FIG. 1 is a schematic configuration diagram of a plating apparatus used in an embodiment 1;

FIGS. 2A and 2B are schematic cross-sectional diagrams of a polymer substrate produced in the embodiment 1, FIG. 2A is a diagram that a mount and a lens holder are disassembled, and FIG. 2B is a diagram that the mount and the lens holder are combined;

FIG. 3 is a schematic cross-sectional diagram of the polymer substrate after the polymer substrate is surface-modified in a manufacturing method of the polymer member of the embodiment 1;

FIG. 4 is a schematic cross-sectional diagram of the polymer member after a plating film is formed on a surface of the polymer substrate in the manufacturing method of the polymer member of the embodiment 1;

FIG. 5 is a SEM image of the polymer member produced in the embodiment 1;

FIG. 6 is a schematic configuration diagram of a plating apparatus used in an embodiment 2;

FIG. 7 is a schematic configuration diagram of a manufacturing apparatus used in an embodiment 6;

FIGS. 8A and 8B are diagrams showing states when pressurized carbon dioxide in which a metal complex is dissolved is introduced into molten resin in a platicizing cylinder, FIG. 8A is a diagram showing a state when the platicizing and measuring of the molten resin are completed, and FIG. 8B is a diagram showing a state when the pressurized carbon dioxide is introduced;

FIG. 9 is a diagram showing a state when injection molding of a polymer molded article is completed in a manufacturing method of a polymer molded article of the embodiment 6;

FIG. 10 is a diagram showing a state when electroless plating processing is applied to the polymer molded article in the manufacturing method of the polymer molded article of the embodiment 6;

FIG. 11 is a diagram schematically showing a cross-sectional structure of the polymer molded article produced in the embodiment 6;

FIG. 12 is a flowchart used to explain the procedure of a method of forming a plating film and the method of manufacturing the polymer member in the embodiment 1;

FIG. 13 is a flowchart used to explain the procedure of a method of forming a plating film and a method of forming a polymer member in the embodiment 6;

FIG. 14 is a diagram schematically showing a cross-sectional structure of an inside in the vicinity of a surface of a polymer substrate produced in an embodiment 7;

FIG. 15 is a diagram schematically showing a cross-sectional structure in the vicinity of a boundary surface between the polymer substrate and a plating film of a polymer member fabricated in the embodiment 7;

FIG. 16 is a diagram showing how molten resin in a mold flows when a polymer substrate is injection-molded in an embodiment 8;

FIG. 17 is a diagram showing a state of the molten resin in the mold when the injection molding of the polymer substrate is completed in the embodiment 8;

FIG. 18 is a diagram showing a state when fine foamed cells are formed in the resin by reducing resin inner pressure after the injection molding in the embodiment 8;

FIG. 19 is a diagram schematically showing a cross-sectional structure of a polymer member produced in the embodiment 8;

FIG. 20 is a flowchart used to explain the procedure of a method of forming the plating film and a method of manufacturing the polymer member in the embodiment 7;

FIG. 21 is a flowchart used to explain the procedure of a method of forming a plating film and a method of manufacturing the polymer member in the embodiment 8; and

FIG. 22 is a flowchart used to explain the procedure of the injection molding in the method of forming the plating film and the method of manufacturing the polymer member in the embodiment 8.

### PREFERABLE EMBODIMENTS FOR CARRYING OUT THE INVENTION

Hereinafter, embodiments of a method of manufacturing a polymer member according to the present invention will be concretely explained with reference to the drawings, but the embodiments hereinafter described are preferable concrete embodiments of the present invention and the present invention is not limited to these embodiments.

### Embodiment 1

In the embodiment 1, a method of forming an electroless plating film on a surface of a polymer substrate by batch processing will be explained.

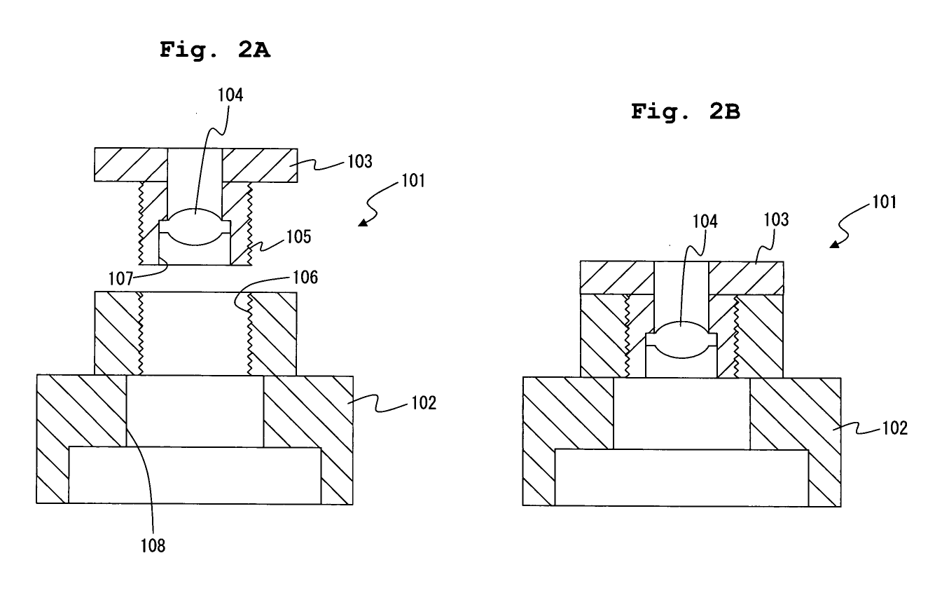

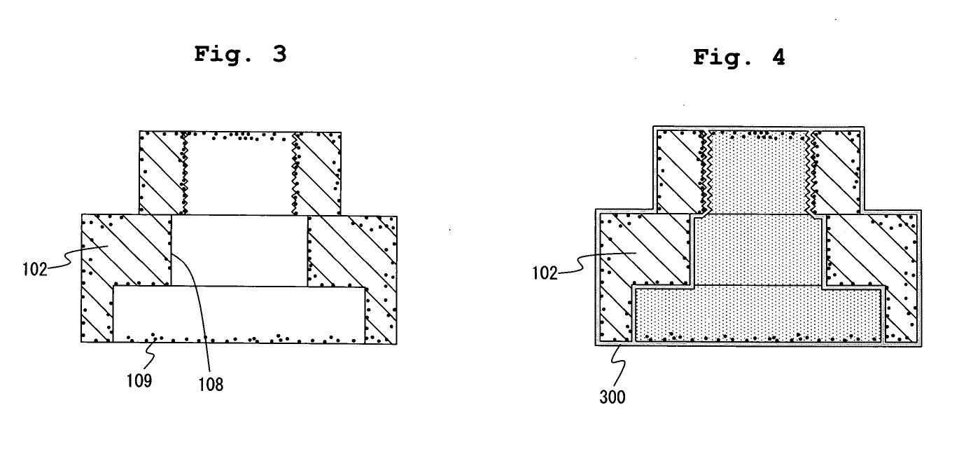

In this embodiment, as a polymer substrate, a mount of a camera lens module used in a cellular phone, a digital camera, and so on was used. Schematic cross-sectional diagrams of the polymer substrate of this embodiment are shown in FIGS. 2A and 2B. As shown in FIGS. 2A and 2B, a camera lens module 101 includes a mount 102 having an inner hole 108, a lens 104, and a lens holder 103 fixing the lens 104. FIG. 2A is a diagram that the mount 102 and the lens holder 103 are disassembled and FIG. 2B is a diagram that the mount 102 and the lens holder 103 are combined. As shown in FIG. 2A, the lens holder 103 has an inner hole 107 and the lens 104 is fixed in the inner hole 107. Further, under the camera module 101, a not-shown image pickup device such as a C-MOS sensor is fixed.

As shown in FIG. 2A, a screw groove 105 is formed on an outer wall of the lens holder 103, and a screw groove 106 engaged with the screw groove 105 of the lens holder 103 is formed on an upper end portion of an inner wall 108 of the inner hole 108 of the mount 102. By engaging the screw groove 105 of the lens holder 103 and the screw groove 106 of the mount 102, the mount 102 and the lens holder 103 are combined, as shown in FIG. 2B.

In addition, in the camera lens module 101 used in the cellular phone, the digital camera, and so on, a subject image is formed on a sensor of the image pickup device such as a CCD or a C-MOS via the lens 104, and as a method to reduce adverse effect on the module by electric signal noise from a body of the cellular phone, it is desirable to shield the mount 102 adjacent to the image pickup device from an electromagnetic wave. However, in a case that a plating film is formed all over the mount 102, when the inner wall surface of the mount 102 is a metal luster film, light is reflected inside the mount 102, which in turn will be a cause of ghost flare. Therefore, in a final step of the method of manufacturing the polymer member of this embodiment, black electroless plating was performed to the surface of the mount 102.

Further, in this embodiment, as a material for forming the polymer substrate 102 (mount), reinforced polyphthalamide (Amodel AS-1566HS manufactured by Solvay Advanced Polymers) containing 65% glass fiber and mineral was used.

[Plating Apparatus]

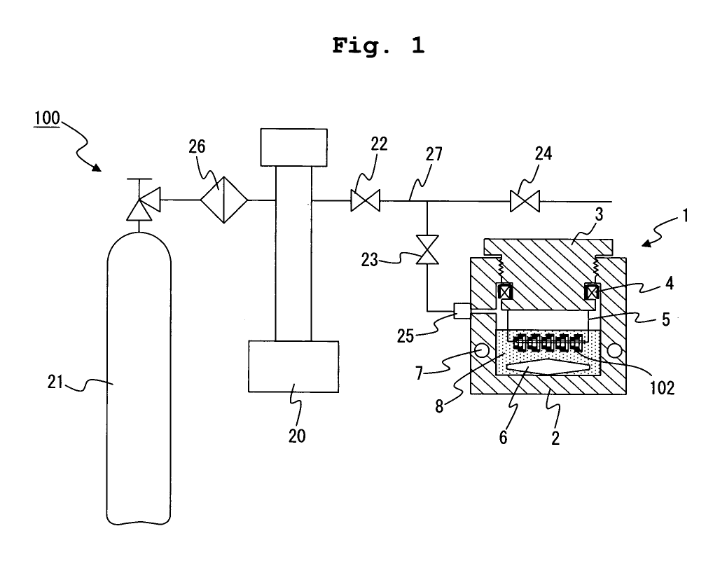

A schematic configuration diagram of a plating apparatus used in the embodiment 1 is shown in FIG. 1. As shown in FIG. 1, a plating apparatus 100 is mainly composed of a carbon dioxide cylinder 21, a filter 26, a high-pressure syringe pump 20, and a high-pressure container 1, and these constituent elements are connected by a pipe 27. Further, as shown in FIG. 1, in the pipe 27 connecting the constituent elements, hand valves 22 to 24 for controlling the flow of pressurized carbon dioxide are provided at predetermined positions.

As shown in FIG. 1, the high-pressure container 1 (high-pressure container body) is composed of a container main body 2 in which an electroless plating solution 8 and the polymer substrate 102 (polymer) are put, and a cover 3. In the cover 3, a polyimide seal 4 housing a well known spring therein is provided, and the polyimide seal 4 seals high-pressure gas in the high-pressure container 1. Further, a holding member 5 capable of holding a plurality of the polymer substrates 102 in a state that they are hung in the electroless plating solution 8 is provided on a plating solution 8 side surface (lower surface) of the cover 3. On a bottom portion in the container body 2, a magnetic stirrer 6 for stirring the electroless plating solution 8 is provided. Further, the container body 2 has a temperature control channel 7, and temperature-controlled water whose temperature is controlled by a thermoregulator (not shown) passes through the temperature control channel 7 to adjust the temperature of the high-pressure container 1. In addition, in this embodiment, the temperature can be adjusted to any temperature in a range from 30° C. to 145° C. Further, as shown in FIG. 1, on a sidewall portion of the container body 2, an inlet port 25 of the pressurized carbon dioxide is provided.

As a material forming the high-pressure container 1, it is desirable to use a material not easily corroded, and SUS316, SUS316L, Inconel, Hastelloy, titanium, or the like is usable. In this embodiment, SUS316L was used as the material forming the high-pressure container 1.

Further, in this embodiment, on an inner wall surface of the high-pressure container 1, a film formed of DLC (diamond-like carbon) (hereinafter, referred to as a plating ungrowable film) was formed by CVD (Chemical Vapor Deposition). This is because of the following reason.

In a conventional electroless plating method, a resin container is generally used as a plating solution container, but in plating methods using a plating solution containing pressurized carbon dioxide as described in, for example, the above Japanese Patent Publication No. 3571627, “Surface Technology” (Vol. 56, No. 2, page 83, 2005), and so on, it is necessary to cause a plating reaction in a high-pressure container, that is, in a metal container requiring pressure resistance. However, according to verifying experiments performed by the present inventors, it has been found out that the use of a metal material such as SUS for the high-pressure container causes the growth of a plating film also on a surface of the high-pressure container which is not an object to be plated (polymer substrate) to destabilize the plating bath, and as a result, makes it difficult to grow a uniform metal film on the object to be plated. It has been also found out that poor adhesion of the plating film growing on the surface of the container causes a problem that the plating film growing on the surface of the container peels off during the plating and is mixed as an extraneous substance in the polymer member. That is, it has become clear that, in the plating method using the electroless plating solution containing pressurized carbon dioxide, the use of the metal high-pressure container as a container for the electroless plating solution is difficult to realize an industrialization of the above method due to the above-described problems.

To solve the above-described problems, in this embodiment, the plating ungrowable film (DLC) was formed on the inner wall surface of the high-pressure container 1 to prevent the growth of the plating film on the inner wall surface. In addition, as a material forming the plating ungrowable film, a material inert to the electroless plating solution, that is, any material on whose surface the plating film does not grow, is usable. For example, usable is a dense carbon film such as diamond-like carbon (hard carbon film), a thin film formed of an organic substance such as PTFE (polytetrafluoroethylene) or PEEK (polyetheretherketon), which is not easily damaged by supercritical carbon dioxide, is usable. These thin films can be formed by using radio-frequency plasma CVD, sputtering, thermal spraying, painting, or the like. Alternatively, a stable metal film of gold (Au) or titanium may be coated by plating or sputtering.

Further, in this embodiment, as the electroless plating solution 8, nickel-phosphorus was used. As the electroless plating solution, nickel-boron, palladium, copper, silver, cobalt, or the like may be also used. Further, as the electroless plating solution 8, a solution capable of plating in a neutral, alkalescent to acid bath is suitable, and nickel-phosphorus is desirable because it can be used in a range from pH4 to 6. In addition, depending on the condition of the electroless plating solution 8 before the pressurized carbon dioxide is introduced thereto, there is a fear that the permeation (introduction) of the pressurized carbon dioxide into the electroless plating solution may cause an adverse effect that pH of the electroless plating solution 8 is lowered and phosphorus concentration increases, resulting in a decrease in deposition rate of the plating film, and therefore, pH of the electroless plating solution 8 may be increased in advance.

In this embodiment, as a concentrate solution of the electroless plating solution 8, NICORON DK manufactured by Okuno Chemical Industries Co., Ltd., which contains metallic salt of nickel sulfate, a reducing agent, a complexing agent, and so on, was used. Further, alcohol was blended in the electroless plating solution 8. Any kind of alcohol is usable in this embodiment, and methanol, ethanol, n-propanol, isopropanol, butanol, heptanol, ethylene glycol, or the like is usable, and in this embodiment, ethanol was used. More concretely, a ratio of the components in the electroless plating solution 1 liter was 150 ml of the concentrate solution (NICORON DK manufactured by Okuno Chemical Industries Co., Ltd.) containing metallic salt of nickel sulfate, the reducing agent, the complexing agent, and so on, 350 ml of water, and 500 ml of alcohol (ethanol). That is, the ratio of alcohol in the electroless plating solution 8 was 50%. In addition, the addition amount of alcohol exceeding 80% is not applicable because in this case, a large amount of nickel sulfate settles due to its insolubility in alcohol.

According to investigations performed by the present inventors, it has been found out that, although the main component of the electroless plating is water, blending alcohol in the electroless plating solution 8 makes it easy to stably mix carbon dioxide in a high-pressure state with the electroless plating solution. A possible reason for this is that alcohol and supercritical carbon dioxide are easily mixed with each other. Therefore, blending alcohol in the electroless plating solution as in this embodiment eliminates a need for adding a surfactant to the electroless plating solution and stirring the electroless plating solution. Moreover, in order to cause a plating reaction in the inside or inner part of the polymer substrate by impregnating the plating solution together with the pressurized carbon dioxide into the polymer substrate, adding alcohol to the plating solution is more preferable since this decreases surface tension more than that of the case adding only water. However, in the present invention, in order to more increase compatibility (affinity) between the pressurized carbon dioxide and the electroless plating solution, a surfactant may be added or the electroless plating solution may be stirred. In this embodiment, a surfactant was added to the electroless plating solution and the electroless plating solution was also stirred as described later.

Further, in this embodiment, as the surfactant, 3 wt % of octaethyleneglycol monododecyl ether was added to the electroless plating solution 8.

In addition, the syringe pump 20 of the plating apparatus 100 used in this embodiment is structured to control the pressure to a constant value in a state that the hand valves 22, 23 are open, so as to be capable of absorbing pressure change even when the temperature in the high-pressure container 1 and the density of the pressurized carbon dioxide change, whereby the pressure in the high-pressure container 1 can be stably kept.

[Method of Manufacturing a Polymer Member]

First, the polymer substrate 102 (mount) having metallic fine particles impregnated on and inside the surface thereof was produced (prepared) in the following manner. The polymer substrate 102 in a predetermined shape shown in FIG. 2 was molded by injection molding. Next, the polymer substrate 102 which had been molded and a metal complex were loaded in a high-pressure container (not shown) of a surface modifying apparatus (not shown). At this time, the polymer substrate 102 was held in the high-pressure container so that the whole surface of the polymer substrate 102 would bring into contact with carbon dioxide in a supercritical state (hereinafter, referred to as supercritical carbon dioxide) introduced later into the high-pressure container. Further, in this embodiment, as the metal complex, hexafluoroacetylacetonato palladium (II) was used.

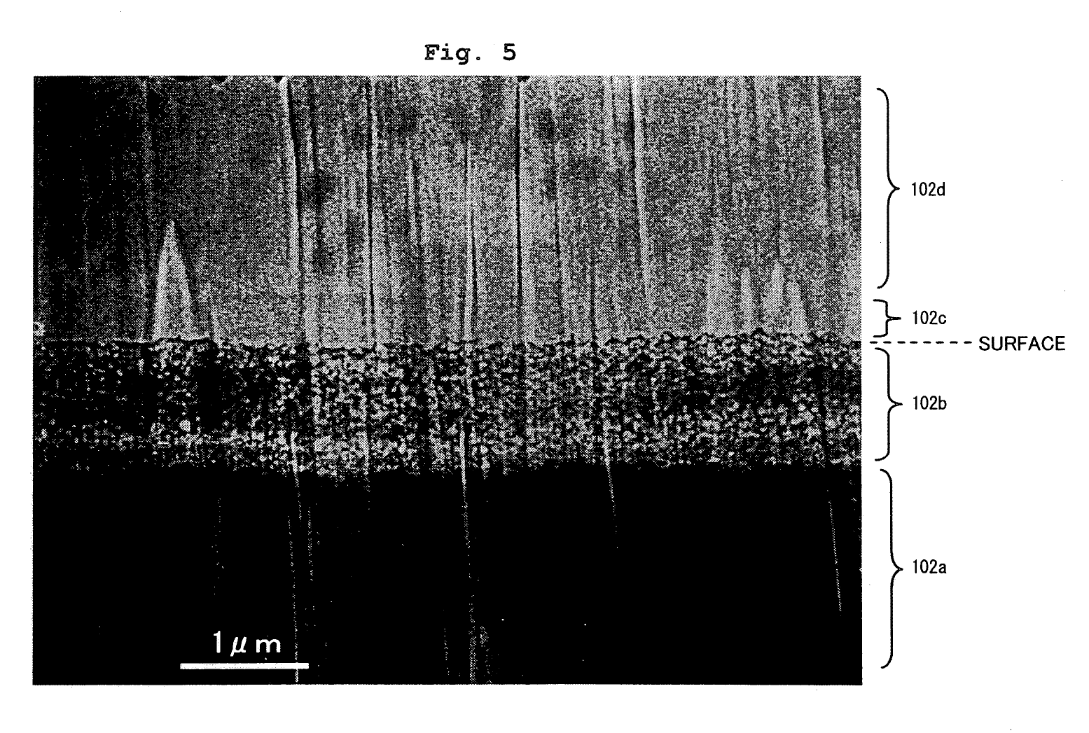

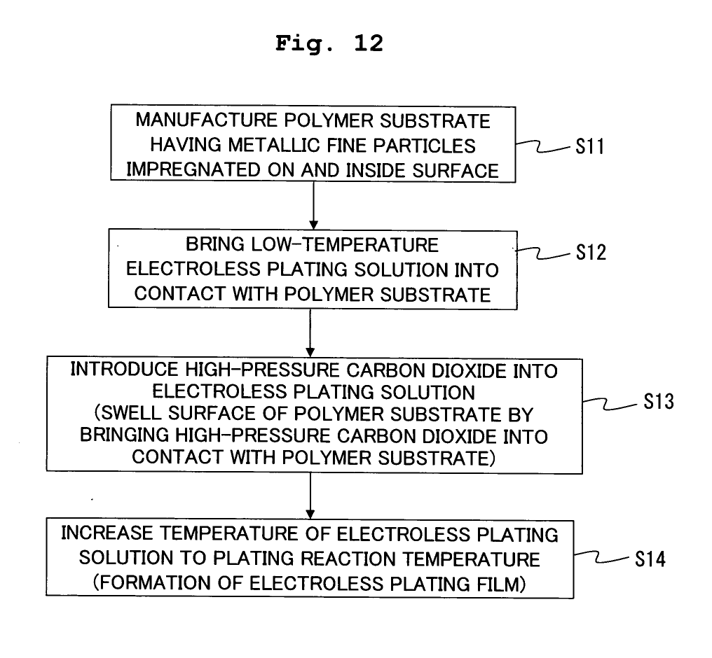

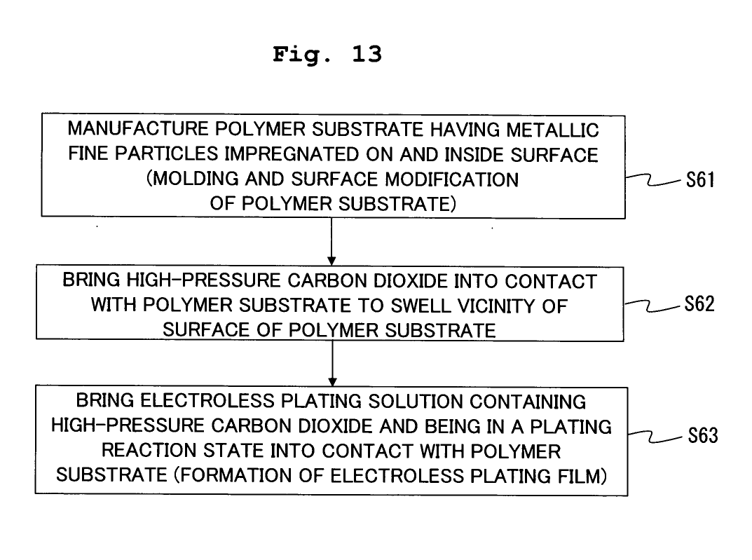

Next, the supercritical carbon dioxide at 15 MPa was introduced into the high-pressure container. At this time, the metal complex previously loaded in the high-pressure container dissolves in the supercritical carbon dioxide and is impregnated together with the supercritical carbon dioxide into the whole surface of the polymer substrate 102. Next, the pressure in the high-pressure container was kept at 120° C. for 30 minutes, so that a part of the metal complex which has been impregnated on and inside the whole surface of the polymer substrate 102 is reduced. In this embodiment, the polymer substrate 102 having the metallic fine particles impregnated on and inside the surface was produced in this manner (Step S11 in FIG. 12). FIG. 3 shows this state, and the black circles in FIG. 3 are the metallic fine particles which have been impregnated on and inside the surface of the polymer substrate 102.

Next, after the polymer substrate 102 produced by the above-described manner was loaded on the holding member 5 of the cover 3 of the high-pressure container 1 shown in FIG. 1, the polymer substrate 102 was inserted into the container body 2 and the cover 3 was closed to close and seal the high-pressure container 1. In addition, in the container body 2, the electroless plating solution 8 corresponding to 70% of the internal volume of the container body 2 is filled in advance, and when the container body 2 is closed and sealed by the cover 3, a plurality of the polymer substrates 102 are brought into a state that they are hung in the electroless plating solution 8 containing the surfactant and alcohol (the state in FIG. 1, Step S12 in FIG. 12). However, at this point in time, the temperature of the high-pressure container 1 and the electroless plating solution 8 was adjusted to 50° C., which is below the plating reaction temperature (temperature in a range of 70° C. to 85° C.), by the temperature-controlled water flowing through the temperature control channel 7 of the high-pressure container 1. Therefore, at this point in time, the polymer substrates 102 are brought in contact with the electroless plating solution at low temperature (temperature not causing the plating reaction) below the plating reaction temperature, and therefore no plating film grows on the polymer substrate 102.

Next, in the following manner, pressurized carbon dioxide was introduced into the high-pressure container 1 whose temperature was controlled to the low temperature not causing the plating reaction. In addition, in this embodiment, as the pressurized carbon dioxide, supercritical carbon dioxide was used. First, liquid carbon dioxide taken out from the liquid carbon dioxide cylinder 21 was sucked up by the high-pressure syringe pump 20 via the filter 26, and then was increased in pressure to 15 MPa in the pump (the supercritical carbon dioxide was produced). Next, the hand valves 22, 23 were opened and the supercritical carbon dioxide at 15 MPa was introduced into the high-pressure container 1 via the inlet port 25 to be brought into contact with the polymer substrate 102 (Step S13 in FIG. 12). At this time, since the surfaces of the polymer substrate 102 is swollen due to the introduced supercritical carbon dioxide and surface tension of the plating solution containing the supercritical carbon dioxide has become lower, the electroless plating solution 8 together with the supercritical carbon dioxide permeates into the inside of the polymer substrate 102. As a result, the electroless plating solution 8 reaches the metallic fine particles existing in the inside of the polymer substrate 102. In addition, in this embodiment, due to the alcohol contained in the electroless plating solution 8, the surface tension of the electroless plating solution 8 further decreases, which makes it easier for the electroless plating solution 8 to permeate into the inside of the polymer substrate 102.

In addition, in this embodiment, after the supercritical carbon dioxide was introduced, the magnetic stirrer 6 was rotated at high speed to stir the electroless plating solution 8. As described above, in this embodiment, since the alcohol is contained in the electroless plating solution, sufficient compatibility can be obtained between the supercritical carbon dioxide and the plating solution even when the electroless plating solution 8 is not diffused by using the magnetic stirrer 6, but in this embodiment, in order to obtain higher compatibility between the supercritical carbon dioxide and the plating solution, the electroless plating solution 8 was stirred by the magnetic stirrer 6.

Next, the temperature of the high-pressure container 1 was increased to 85° C. to cause the plating reaction in the high-pressure container 1 (perform electroless plating), thereby forming a plating film on the surface of the polymer substrate 102 (Step S14 in FIG. 12). At this time, in the method of manufacturing the polymer member (the method of forming the plating film) of this embodiment, since the electroless plating solution permeates up to the metallic fine particles existing in the inside of the polymer substrate 102 as described above, the plating film not only grows on the surface of the polymer substrate 102 but also grows from the metallic fine particles existing in the inside of the polymer substrate 102 serving as catalyst cores. That is, in the method of manufacturing the polymer member of this embodiment, the plating film grows also in a free volume of the inside of the polymer substrate 102, and consequently, the plating film is formed on the polymer substrate 102 in a state that a part of the plating film penetrates into the inside of the polymer substrate 102 (in a state that the plating film enters in the inside of the polymer substrate 102).

After the plating was finished, the magnetic stirrer 6 was stopped to leave at rest for a short period, and the carbon dioxide and the plating solution were separated into two phases in the high-pressure container 1. Thereafter, the hand valve 22 was closed and the hand valve 24 was opened, and then the carbon dioxide in the high-pressure container 1 was discharged. Next, the high-pressure container 1 was opened and the polymer substrate 102 was taken out of the high-pressure container 1. When the polymer substrate 102 which was taken out was visually observed, metallic luster was recognized on the whole surface of the polymer substrate 102.

Next, in order to expel the carbon dioxide and the electroless plating solution from the inside of the polymer substrate 102 taken out of the high-pressure container 1, the polymer substrate 102 was annealed at 150° C. for one hour. Next, a surface of the oxidized plating film was activated by hydrochloric acid. Thereafter, by using a conventional electroless nickel-phosphorus solution, electroless plating was performed in the atmosphere at atmospheric pressure to laminate a plating film of 500 nm, and electroless copper plating film of 1 μm was further laminated thereon to form an electromagnetic shield film. Next, black electroless plating was carried out to laminate a black electroless nickel-phosphorus plating film on the electroless copper plating film. Blackening was performed by roughing the surface by etching, after plating was carried out by using a specialized electroless nickel-phosphorus solution. This is intended to blacken the inner wall of the polymer substrate 102 (mount) to inhibit ghost flare caused by light reflection. In this embodiment, the polymer members in which the whole surface of the polymer substrate 102 was covered by the metal film (reference numeral 300 in FIG. 4) as shown in FIG. 4 were obtained in the above-described manner.

[Evaluation of the Plating Film]

The polymer member manufactured in the above-described manner was subjected to a high-temperature high-humidity test (condition: temperature 80° C., humidity 90% Rh, standing time 500 hours) and a heat cycle test (15 cycles between 80° C. and 150° C.), and thereafter was subjected to a peeling test, but no peeling occurred. Further, after the above processes of this embodiment were repeated, no growth of a plating film in the high-pressure container 1 and no corrosion of the container inner wall of the container were recognized.

A cross section of the polymer member manufactured in this embodiment was observed by a SEM (scanning electron microscope). The result is shown in FIG. 5. An area 102a in FIG. 5 is an area, of the polymer substrate 102, where the plating film is not formed, and an area 102b is a layer (second area) that a part of the plating film penetrates into the inside of the polymer substrate 102. Further, an area 102c in FIG. 5 is an area of the metal film which was formed when the electroless plating was carried out in the atmosphere at atmospheric pressure by using the conventional electroless nickel-phosphorus solution, and an area 102d in FIG. 5 is an area of the electroless copper plating film. Therefore, the vicinity of the boundary between the area 102b and the area 102c is the uppermost surface of the polymer substrate 102. As is apparent from the observed image in FIG. 5, it was confirmed that the layer where the metal film grew in the inside of the polymer substrate 102 (the area 102b in FIG. 5) was formed. It was also found out that a part of the plating film penetrated up to the depth of about 1 μm from the surface of the polymer substrate 102. In addition, the penetration depth of the metal film can be appropriately changed depending on a material of the polymer substrate, a process condition, and so on.

In this embodiment, Ni, P, and Pd were detected when metals existing in the inside of the polymer substrate 102 were component-analyzed by an XRD (X-ray diffractometer). It has been confirmed from this result that Pd derived from the metal complex which has been impregnated into the inside of the polymer member 102 works as a catalyst and consequently a Ni—P plating film grows in the inside of the polymer. Further, in this embodiment, Pd was detected at a position deeper than the penetration depth of the plating film of the polymer substrate 102. Concretely, Pd was detected in an area (first area) up to a depth position about 500 μm from the surface of the polymer substrate 102.

### Embodiment 2

In the embodiment 2, a method of forming an electroless plating film on a surface of a polymer substrate by batch processing will be explained in the same manner as in the embodiment 1. In this embodiment, as a high-pressure container in an plating apparatus, a high-pressure container having a different structure from that of the embodiment 1 was used. An electroless plating solution used in this embodiment was the same as that used in the embodiment 1. Further, in this embodiment, a metal film was formed on a surface of a mount (mount 102 having the structure shown in FIGS. 2A and 2B) of a camera lens module in the same manner as in the embodiment 1. As pressurized carbon dioxide introduced into an electroless plating solution, supercritical carbon dioxide was used.

[Plating Apparatus]

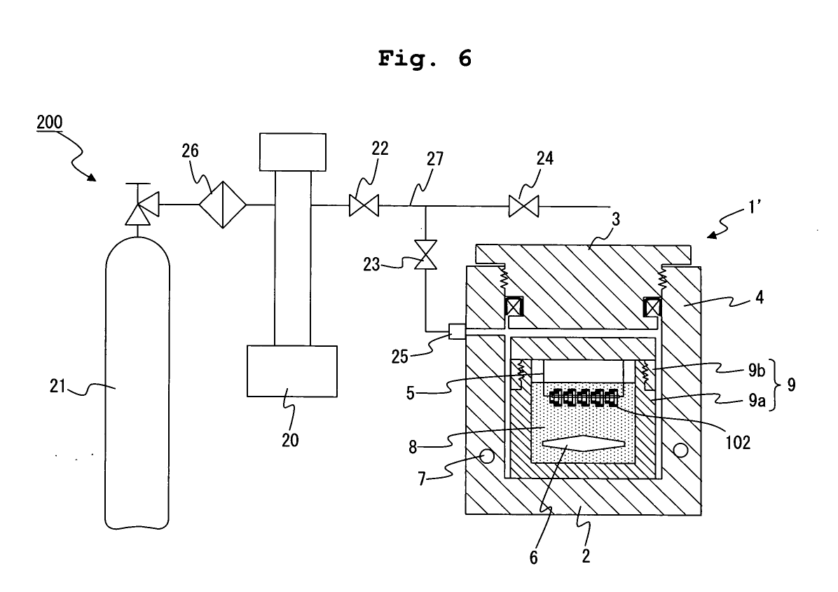

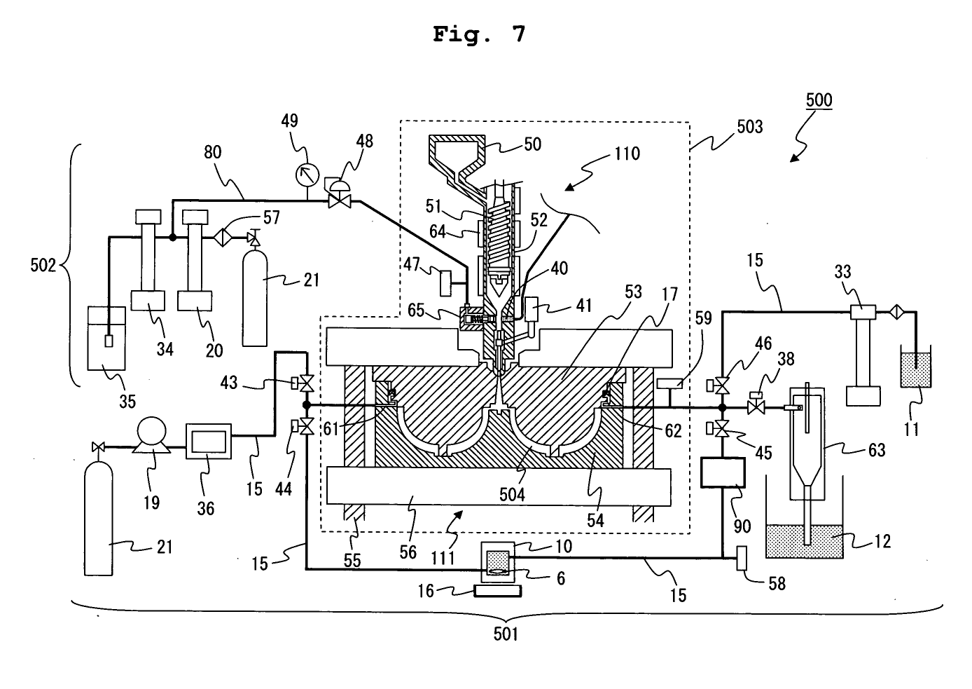

A schematic configuration diagram of the plating apparatus used in the embodiment 2 is shown in FIG. 6. As shown in FIG. 6, a plating apparatus 200 is mainly composed of a carbon dioxide cylinder 21, a filter 26, a high-pressure syringe pump 20, and a high-pressure container 1′, and these constituent elements are connected by a pipe 27. Further, as shown in FIG. 6, in the pipe 27 connecting the constituent elements, hand valves 22 to 24 for controlling the flow of the supercritical carbon dioxide are provided at predetermined positions.

As shown in FIG. 6, the high-pressure container 1′ is composed of a container body 2, a cover 3, and an inner container 9 housed in the container body 2. The cover 3 has the same structure as that of the embodiment 1 except that the cover 3 does not include a holding member holding the polymer substrates 102 unlike the embodiment 1. The container body 2 of this embodiment has the same structure as that of the embodiment 1 except that the container body 2 does not have a plating ungrowable film on inner wall surface thereof.

In the plating apparatus 200 of this embodiment, the inner container 9 formed of PTFE (polytetrafluoroethylene) and housable in the container body 2 made of metal was used, and electroless plating was performed to the polymer substrates 102 in this inner container 9. In this embodiment, since the inner container formed of a material on which a plating film does not grow is used and the electroless plating is performed therein, a plating solution does not easily bring into direct contact with the inner wall of the high-pressure container housing the inner container, which enables stable plating. Further, in this case, no coating of the inner wall of the high-pressure container is required, and thus the apparatus costs low. In addition, since diffusibility of the electroless plating solution in which the pressurized carbon dioxide is dispersed is low, the electroless plating solution does not substantially leak to the outside of the inner container. Further, as the material other than polytetrafluoroethylene (PTFE) forming the inner container, resin materials such as polyetheretherketon (PEEK) and polyimide, a material mixed any of these resin materials and an inorganic substance such as glass fiber, and as a metal material, a metal material such as titanium, Hastelloy, or Inconel are usable.

As shown in FIG. 6, the inner container 9 is composed of a container body portion 9a in which an electroless plating solution 8 and the polymer substrates 102 are put, and a cover portion 9b. On a surface (lower surface) of the cover portion 9b, which faces to an electroless plating solution 8, a holding member 5 capable of holding a plurality of the polymer substrates 102 in a state where they are hung in the electroless plating solution 8 is provided. This holding member 5 has the same structure as that of the holding member of the embodiment 1. In a bottom portion in the container body 9a, a magnetic stirrer 6 for stirring the electroless plating solution 8 is provided. Further, a screw groove is formed on an outer wall in the vicinity of upper end of the container body portion 9a, and on an inner wall of the cover portion 9b, a screw groove engaged with the screw groove provided in the outer wall of the upper end of the container body portion 9a is formed. The inner container 9 is structured to be closed by the engagement of the screw groove of the container main body portion 9a and the screw groove of the cover portion 9b.

[Method of Manufacturing a Polymer Member]

First, in this embodiment, the polymer substrate 102 (the mount 102 having the shape shown in FIGS. 2A and 2B) having metallic fine particles impregnated on and inside the surface thereof was produced (prepared) in the same manner as in the embodiment 1. In this embodiment, as a metal complex, hexafluoroacetylacetonato palladium (II) was used.

Next, after the polymer substrate 102 which had been molded was loaded on the holding member 5 of the cover portion 9b of the inner container 9 shown in FIG. 6, the polymer substrate 102 was inserted in the container body 9a and the cover portion 9b was closed. At this time, a state was obtained that a plurality of the polymer substrates 102 are hung in the electroless plating solution 8 containing a surfactant and alcohol, as shown in FIG. 6. Then, this state was maintained at room temperature. Therefore, at this point in time, since the temperature of the electroless plating solution 8 is below the plating reaction temperature (temperature in a range of 70° C. to 85° C.), a plating film does not grow on the surface of the polymer substrate 102.

Next, the inner container 9 was inserted in the high-pressure container 1′ whose temperature was adjusted to 90° C. in advance, the cover 3 was closed, and immediately, supercritical carbon dioxide was introduced into the high-pressure container 1′ via an inlet port 25 in the same manner as in the embodiment 1. Thereafter, the electroless plating solution 8 was stirred by the magnetic stirrer 6. At this time, the container body portion 9a and the cover portion 9b of the inner container 9 are engaged by the threads as described above, but even in this state, the supercritical carbon dioxide is sufficiently introduced into the inner container 9 from small gaps in portions, of the inner container 9, engaged by the threads because the supercritical carbon dioxide has low viscosity and high diffusibility. Further, at this point in time, the temperature in the inner container 9 does not rapidly increase because resin having low heat conductivity is used for the inner container 9, and therefore, the temperature of the inner container 9 is at temperature lower than the temperature causing the plating reaction, and no plating film grows on the surface of the polymer substrate 102. Therefore, when the supercritical carbon dioxide is introduced immediately after the inner container 9 is inserted into the high-pressure container 1′, the surface of the polymer substrate 102 is swollen in the same manner as in the embodiment 1, and since surface tension of the plating solution in which the supercritical carbon dioxide is mixed has become low, the electroless plating solution together with the supercritical carbon dioxide permeates into the inside of the polymer substrate 102, and consequently, the electroless plating solution reaches the metallic fine particles existing in the inside of the polymer substrate 102.

Thereafter, the temperature in the inner container 9 increases with time, and the temperature of the electroless plating solution 8 and so on finally increases up to the plating reaction temperature. At this instant, the plating reaction occurs in the inner container 9 and the plating film grows on the surface of the polymer substrate 102. At this time, in the method of manufacturing the polymer member of this embodiment, since the electroless plating solution permeates up to the metallic fine particles existing in the inside of the polymer substrate 102 as described above, the plating film grows not only on the surface of the polymer substrate 102 but also grows from the metallic fine particles existing in the inside serving as catalyst cores. That is, in the method of forming the plating film of this embodiment, the plating film is formed on the polymer substrate 102 in a state that a part of the plating film penetrates into the inside of the polymer substrate 102.

Next, after the above plating processing (after about 30 minutes pass from the insertion of the inner container 9), the supercritical carbon dioxide was discharged from the high-pressure container 1′ and the temperature of the inner container 9 was controlled and kept at 90° C. By this process, a plating film was further grown at atmospheric pressure on the plating film growing from the inside of the polymer substrate 102. Thereafter, the inner container 9 was taken out of the high-pressure container 1′, and then the polymer substrate 102 was taken out of the inner container 9. Next, electroless copper plating and black electroless nickel-phosphorus plating were performed to the polymer substrate 102 taken out of the inner container 9, in the same manner as in the embodiment 1. In this embodiment, polymer member in which the whole surface was covered by a metal film (reference numeral 300 in FIG. 4) as shown in FIG. 4 was obtained by the method as described above.

[Evaluation of the Plating Film]

The polymer members manufactured in the above manner was subjected to environmental tests (high-temperature high-humidity test, heat cycle test) and adhesion evaluation (peeling test) in the same manner as in the embodiment 1, and as a result, it has been found out that a plating film with high adhesion is formed on the polymer substrate 102, as in the embodiment 1.

Further, no plating solution was observed inside the high-pressure container 1′ of this embodiment. Therefore, in a case that the resin inner container is used as in this embodiment, plating film does not grow on the inner wall of the high-pressure container 1′ even when the inside of the high-pressure container 1′ is not coated, which enables stable plating. Further, since corrosion of the surface of the high-pressure container 1′ can be prevented, this plating apparatus is suitable for the method of forming the plating film using supercritical carbon dioxide.

### Embodiment 3

In the embodiment 3, a surfactant was not added to an electroless plating solution and the electroless plating solution was not stirred by a magnetic stirrer. Except for this, by using the same plating apparatus and the same method as those of the embodiment 2, electroless plating processing was applied to polymer substrate to produce polymer member.

The polymer members produced in this embodiment was also subjected to environmental tests (high-temperature high-humidity test, heat cycle test) and adhesion evaluation (peeling test) in the same manner as in the embodiment 2, and as a result, it has been found out that a plating film with high adhesion is formed on the polymer substrate, as in the embodiment 2. That is, it has been found out that, according to the method of manufacturing the polymer member of the present invention, it is possible to form a plating film with good adhesion on the polymer substrate even when affinity (compatibility) between supercritical carbon dioxide and an electroless plating solution is not improved by using the surfactant or the magnetic stirrer.

### Embodiment 4

In the embodiment 4, alcohol was not mixed in an electroless plating solution and the pressure of supercritical carbon dioxide introduced into the electroless plating solution was set to high, namely, 20 MPa. Except for this, by using the same plating apparatus and the same method as those of the embodiment 2, electroless plating processing was performed to polymer substrate to produce polymer member.

The polymer member produced in this embodiment was also subjected to environmental tests (high-temperature high-humidity test, heat cycle test) and adhesion evaluation (peeling test) in the same manner as in the embodiment 2, and as a result, it has been found out that a plating film with high adhesion is formed on the polymer substrate, as in the embodiment 2. That is, it has been found out that, according to the method of manufacturing the polymer member of the present invention, it is possible to enhance affinity between a water solvent (electroless plating solution) and supercritical carbon dioxide by using a surfactant and mechanical stirring, even without using alcohol.

### Embodiment 5

In the embodiment 5, an inner wall of a high-pressure container of a plating apparatus was not coated with a plating ungrowable film. Except for this, by using the same plating apparatus as that of the embodiment 1 and the same method as that of the embodiment 1, electroless plating processing was performed to polymer substrate to produce polymer member.

The polymer member produced in this embodiment was also subjected to environmental tests (high-temperature high-humidity test, heat cycle test) and adhesion evaluation (peeling test) in the same manner as in the embodiment 1, and as a result, it has been found out that a plating film with good adhesion is formed on the polymer substrate, as in the embodiment 1. However, in this embodiment, since the plating ungrowable film was not formed on the inner wall of the high-pressure container of the plating apparatus, the growth of the plating film on the inner wall surface of the high-pressure container and corrosion of the inner wall surface were observed.

### Comparative Embodiment 1

In the comparative embodiment 1, except that stirring was not performed in the inner container of the plating apparatus, electroless plating processing was performed to polymer substrate to produce polymer member in the same manner as in the embodiment 4 (the case where alcohol is not mixed in the electroless plating solution).

The polymer member produced in this comparative embodiment was also subjected to environmental tests (high-temperature high-humidity test, heat cycle test) and adhesion evaluation (peeling test) in the same manner as in the embodiment 1. As a result, peeling of an electroless plating film occurred in almost all the produced polymer members. It has been found out from this result that, in a case that alcohol is not mixed in the electroless plating solution, the electroless plating solution needs to be stirred even when the surfactant is added to the electroless plating solution.

### Comparative Embodiment 2

In the comparative embodiment 2, after an electroless plating solution and polymer substrate having metallic fine particles impregnated on and inside the surface thereof were inserted in the inner container of the plating apparatus, the temperature was increased to 80° C. Next, in the same manner as in the embodiment 3, the inner container was inserted into the high-pressure container, supercritical carbon dioxide was introduced, and electroless plating processing was performed. That is, in the comparative embodiment 2, the temperature of the electroless plating solution brought into contact with the polymer substrate was held substantially constant before and after the supercritical carbon dioxide was introduced.

The polymer member produced in this comparative embodiment was also subjected to environmental tests (high-temperature high-humidity test, heat cycle test) and adhesion evaluation (peeling test) in the same manner as in the embodiment 1. As a result, peeling of an electroless plating film occurred in almost all the produced polymer members. A possible reason for this is that, in the method of forming the plating film of the comparative embodiment 2, since the electroless plating solution was adjusted to the plating reaction temperature before the supercritical carbon dioxide was introduced (before the supercritical carbon dioxide was brought into contact with the polymer substrates), the plating reaction occurred and the plating film was deposited on the surface of the polymer substrate before the electroless plating solution permeated into the inside of the polymer substrate, and because of this, the electroless plating solution did not permeate into the inside of the polymer substrate and thus the growth of the plating film in the inside of the polymer substrate was inhibited.

A table summarizing the configurations of the high-pressure container, the condition of the electroless plating solution, and the evaluation results in the above-described embodiments 1 to 5 and the comparative embodiments 1 and 2 is shown in Table 1. In Table 1, evaluation criteria for adhesion of the plating film and a corrosive property of the inner wall of the high-pressure container are as follows.

Adhesion of the Plating Film:

++ in a case that no problem is found in the peeling test after the environmental tests (high-temperature high-humidity, heat cycle tests) (in a case that peeling, blister, and the like of the plating film do not occur)

+ in a case that no problem is found in the peeling test before the environmental tests

− in a case that peeling occurs in the peeling test before the environmental tests

Corrosive Property of the Inner Wall of the Container and the Growth of the Plating Film:

+ in a case that no rust and no growth of the plating film exist on the container inner wall

− in a case that rust or the growth of the plating film occurs on the inner wall of the container

TABLE 1

| | | | | | | | evaluation result | |
|---|---|---|---|---|---|---|---|---|
| | high-pressure container | | | | | plating | | container |
| | inner | | | electroless | | solution | plating | corrosion, |
| | wall | inner | | plating solution | | temperature | film | plating |
| | coating | container | Stirring | alcohol | surfactant | control | adhesion | film growth |
| Embodiment | with | w/o | With | with | with | with | ++ | + |
| 1 | | | | | | | | |
| Embodiment | w/o | with | With | with | with | with | ++ | + |
| 2 | | | | | | | | |
| Embodiment | w/o | with | w/o | with | w/o | with | ++ | + |
| 3 | | | | | | | | |
| Embodiment | w/o | with | With | w/o | with | with | ++ | + |
| 4 | | | | | | | | |
| Embodiment | w/o | w/o | With | with | with | with | ++ | − |
| 5 | | | | | | | | |
| Comparative | w/o | with | w/o | w/o | with | with | − | + |
| embodiment | | | | | | | | |
| 1 | | | | | | | | |
| Comparative | w/o | with | w/o | with | w/o | w/o | − | + |
| embodiment | | | | | | | | |
| 2 | | | | | | | | |

### Embodiment 6

The embodiment 6 will explain a method in which, after a polymer substrate is injection-molded by using an injection molding machine, electroless plating processing is performed in the same injection molding machine. In this embodiment, as a polymer member, a reflector of an automobile headlight was manufactured.

[Manufacturing Apparatus of a Polymer Member]

A schematic configuration of a manufacturing apparatus of the polymer member used in this embodiment is shown in FIG. 7. As shown in FIG. 7, a manufacturing apparatus 500 of this embodiment is mainly composed of: a vertical injection molding apparatus part 503 including a mold; an electroless plating apparatus part 501 controlling the supply and discharge of an electroless plating solution containing pressurized carbon dioxide to/from the mold; and a surface modification apparatus part 502 for impregnating pressurized carbon dioxide in which a metal complex is dissolved into molten resin in a platicizing cylinder of the injection molding apparatus part 503.

As shown in FIG. 7, the vertical injection molding apparatus part 503 is mainly composed of a platicizing/melting apparatus 110 which platicizes/melts the resin for forming the polymer substrate and a clamp device 111 which opens/closes the mold.

The plasticizing/melting apparatus 110 is mainly composed of a platicizing cylinder 52 having therein a screw 51, a hopper 50, and an inlet valve 65 provided near an apical portion (flow front portion) in the platicizing cylinder 52 to introduce pressurized carbon dioxide. Further, a pressure sensor 40 for measuring resin inner pressure is provided at a position facing the inlet valve 65 of the platicizing cylinder 52. As a material of not-shown resin pellets supplied into the platicizing cylinder 52 from the hopper 50 (material forming the polymer substrate), polyphenilene sulfide (FZ-8600 Black manufactured by Dainippon Ink and Chemicals, Incorporated) was used.

The clamp device 111 is mainly composed of a fixed mold 53 and a movable mold 54 and is structured such that, the movable mold 54 operates in conjunction with the driving of a movable platen 56 and a not-shown hydraulic clamp mechanism coupled to the movable platen 56, to open/close space between four tiebars 55. Further, the movable mold 54 has plating solution inlet channels 61, 62 which supply and discharge the pressurized carbon dioxide and the electroless plating solution to/from a cavity 504 defined between the movable mold 54 and the fixed mold 53. As shown in FIG. 7, the plating solution inlet channels 61, 62 are connected to a pipe 15 of the electroless plating apparatus part 501, which will be described later, and the pressurized carbon dioxide and the electroless plating solution are introduced into the cavity 504 via the pipe 15. The cavity 504 is sealed by engaging the movable mold 54 and a spring-equipped seal 17 provided in an outside diameter portion of the fixed mold 53.

As shown in FIG. 7, the surface modification apparatus part 502 is mainly composed of a liquid carbon dioxide cylinder 21, syringe pumps 20, 34, a filter 57, a back pressure regulating valve 48, a dissolver 35 dissolving the metal complex in the pressurized carbon dioxide, and a pipe 80 connecting these constituent elements. Further, as shown in FIG. 7, the pipe 80 of the surface modification apparatus part 502 is connected to the inlet valve 65 of the platicizing cylinder 52, and a pressure sensor 47 is provided in the pipe 80 near the inlet valve 65. In addition, in this embodiment, as a raw material of metallic fine particles prepared in the dissolver 35, a metal complex (hexafluoroacetylacetonato palladium (II)) was used.

As shown in FIG. 7, the electroless plating apparatus part 501 is mainly composed of a liquid carbon dioxide cylinder 21, a pump 19, a buffer tank 36, a high-pressure container 10 in which the electroless plating solution and the pressurized carbon dioxide are mixed, a circulation pump 90, a plating tank 11 for supplying the electroless plating solution, a syringe pump 33, a collection container 63 collecting the electroless plating solution, a collection tank 12, and the pipe 15 connecting these constituent elements. Further, automatic valves 43 to 46, 38 for controlling the flow of the pressurized carbon dioxide and the electroless plating solution are provided at predetermined positions of the pipe 15. Further, as shown in FIG. 7, the pipe 15 is connected to the plating solution inlet channels 61, 62 of the movable mold 54. In addition, in this embodiment, as the electroless plating solution, an electroless plating solution in which same alcohol and same surfactant as that of the embodiment 1 were mixed was used, and the composition thereof was the same as that of the embodiment 1.

[Method of Molding a Polymer Substrate]

Next, a method of molding a polymer substrate having metallic fine particles impregnated on and inside a surface thereof will be explained. Any method may be used as a method of impregnating the metallic fine particles into resin in the present invention. In this embodiment, pressurized carbon dioxide in which the metallic fine particles were dissolved was introduced into an apical portion (flow front portion) of molten resin that was platicized and measured in the platicizing cylinder 52.

First, a metal complex was dissolved in ethanol in the dissolver 35, and the pressure of the ethanol in which the metal complex was dissolved was increased to 15 MPa in the syringe pump 34. Meanwhile, liquid carbon dioxide was supplied from the liquid carbon dioxide cylinder 21 to the syringe pump 20 via the filter 57, and the pressure of the liquid carbon dioxide was increased to 15 MPa in the syringe pump 20. Then, when the produced high-pressure liquid carbon dioxide and high-pressure ethanol in which the metal complex was dissolved were supplied to the platicizing/melting apparatus 110, the control of the syringe pumps 20, 34 was changed from pressure control to flow rate control. At this time, the high-pressure liquid carbon dioxide and the high-pressure ethanol in which the metal complex was dissolved were sent while being mixed in the pipe 80 (hereinafter, a fluid produced by this mixing will be referred to as a pressurized mixed fluid). In addition, when this pressurized mixed fluid was supplied to the platicizing/melting apparatus 110, the supply pressure of the pressurized mixed fluid was controlled by the back pressure regulating valve 48 so that a pressure gage 49 would indicate 15 MPa. Further, when the pressurized mixed fluid was supplied to the platicizing/melting apparatus 110, the pressurized mixed fluid was supplied to the platicizing/melting apparatus 110 while being temperature-controlled to 50° C. in the pipe 80 by a not-shown heater.

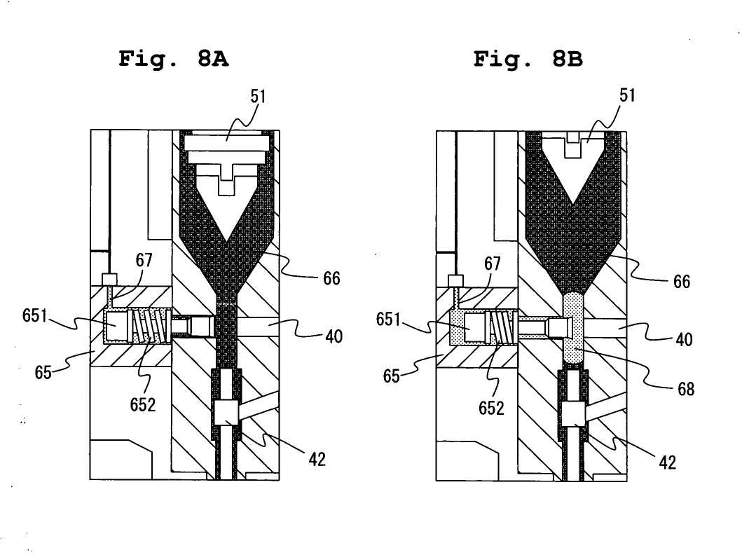

Next, the procedure for introducing the pressurized mixed fluid into the plasticizing/melting apparatus 110 will be explained with reference to FIGS. 7, 8A and 8B. FIGS. 8A and 8B are enlarged cross-sectional diagrams of the vicinity of the inlet valve 65 of the plasticizing/melting apparatus 110. First, while the resin pellets were supplied from the hopper 50, the screw 51 in the plasticizing cylinder 52 was rotated and the resin was plasticized and measured. A state of the vicinity of the inlet valve 65 when the plasticizing and the measurement are completed is shown in FIG. 8A. At this time, as shown in FIG. 8A, an inlet pin 651 of the inlet valve 62 moves back (moves to the left in FIG. 8A), thereby shutting off the introduction of the pressurized mixed fluid 67 into the molten resin 66.

Next, the screw 51 was suck-backed (was moved back) to decrease inner pressure of the molten resin 66, and at the same time, the control of the syringe pumps 20, 34 was changed from pressure control to flow rate control, and the pressurized mixed fluid 67 was introduced to the molten resin 66 at the flow front portion in the plasticizing cylinder 52 via the inlet valve 65 (state in FIG. 8B), while the flow rates of the ethanol in which the metal complex was dissolved and the carbon dioxide were controlled to 1:10 by the above-described method. An area 68 in FIG. 8B is a portion, of the molten resin, into which the pressurized mixed fluid 67 permeated.

In addition, the inlet valve 65 of the plasticizing cylinder 52 of this embodiment is structured to allow the introduction of the pressurized mixed fluid 67 into the molten resin 66 in the plasticizing cylinder 52 when a pressure difference between the molten resin 66 and the pressurized mixed fluid 67 becomes 5 MPa or more, and the principle for introducing the pressurized mixed fluid 67 by the inlet valve 65 is as follows. When the screw 51 is suck-backed after the completion of the plasticizing and measurement, the pressure of the molten resin 66 is reduced, resulting in decrease in its density. Then, when the pressure difference between the molten resin 66 and the pressurized mixed fluid 67 becomes 5 MPa or more, the pressure of the pressurized mixed fluid 67 becomes stronger than a return force (elastic force) of a spring 652 in the inlet valve 65, and consequently, the inlet pin 651 moves forward toward the molten resin 66 side and the pressurized mixed fluid 67 is introduced into the molten resin 66. The pressurized mixed fluid 67 was introduced while the pressures of the molten resin and the pressurized mixed fluid 67 were monitored by the pressure sensors 40, 47 respectively.

Next, the syringe pumps 20, 34 were both stopped to stop sending the pressurized mixed fluid 67. Further, at the same time, the screw 51 was moved forward to increase the resin pressure again, and the inlet pin 64 was moved back (moved to the left in FIG. 8B). By this operation, the introduction of the pressurized mixed fluid 67 was stopped and the pressurized mixed fluid 67 and the molten resin 66 were mixed or solved with each other.

Next, the syringe pumps 20, 34 were both closed by not-shown automatic valves in the pipe 80, and thereafter the pressurized carbon dioxide and the ethanol solution in which the metal complex was dissolved were supplied to the syringe pumps 20, 34 in amounts corresponding to the amounts supplied to the platicizing/melting apparatus 110. Thereafter, the control of the syringe pumps were changed to pressure control, the high-pressure of 15 MPa was maintained, and this state was kept on standby until the solution sending of the next shot.

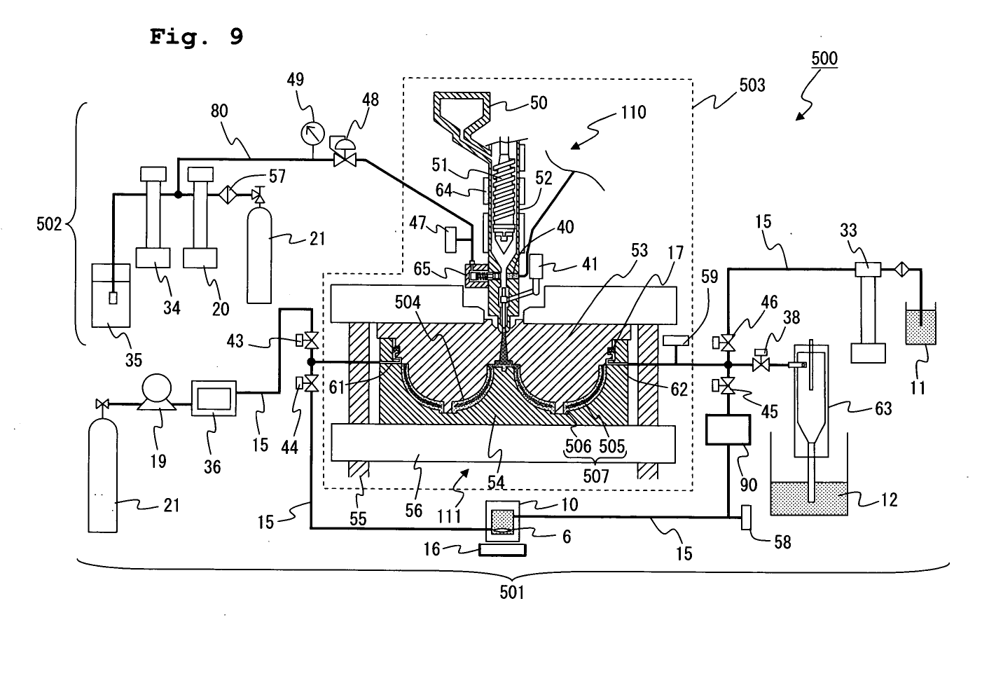

Next, after the pressurized mixed fluid 67 was introduced to the molten resin 66 at the flow front portion in the platicizing cylinder 52, the molten resin was injected to fill the cavity 504 defined in the mold which was clamped by a hydraulic clamp mechanism (not shown) of the clamp device 111 and was temperature-controlled by a temperature regulating circuit (not shown). Next, after a dwell pressure was applied to the mold in order to prevent the foaming of a molded article, the molded article was solidified by cooling (state in FIG. 9). In addition, when the molten resin is injected in the mold for molding, the molten resin 68 at the flow front portion first injected forms an outer layer of the injection-molded article due to a fountain effect (fountain flow). That is, in this embodiment, since the metallic fine particles derived from the metal complex are dispersed in the vicinity of the flow front portion, a polymer substrate 507 in which an outer layer 505 (on and inside the surface) thereof is obtained, as shown in FIG. 9 (Step S61 in FIG. 13). In this embodiment, by the above-described method, the polymer substrate 507 was obtained in which the metallic fine particles were dispersed in the skin layer 505 thereof as the outer layer and few metallic fine particles existed in a core layer 506 as an inner layer thereof.

[Method of Forming a Plating Film]

The polymer substrate 507 produced by the above-described method, which has the metallic fine particles dispersed on and inside the surface, was subjected to electroless plating processing in the mold in the following manner. In addition, during the electroless plating processing, the temperature in the mold was adjusted to 80° C.

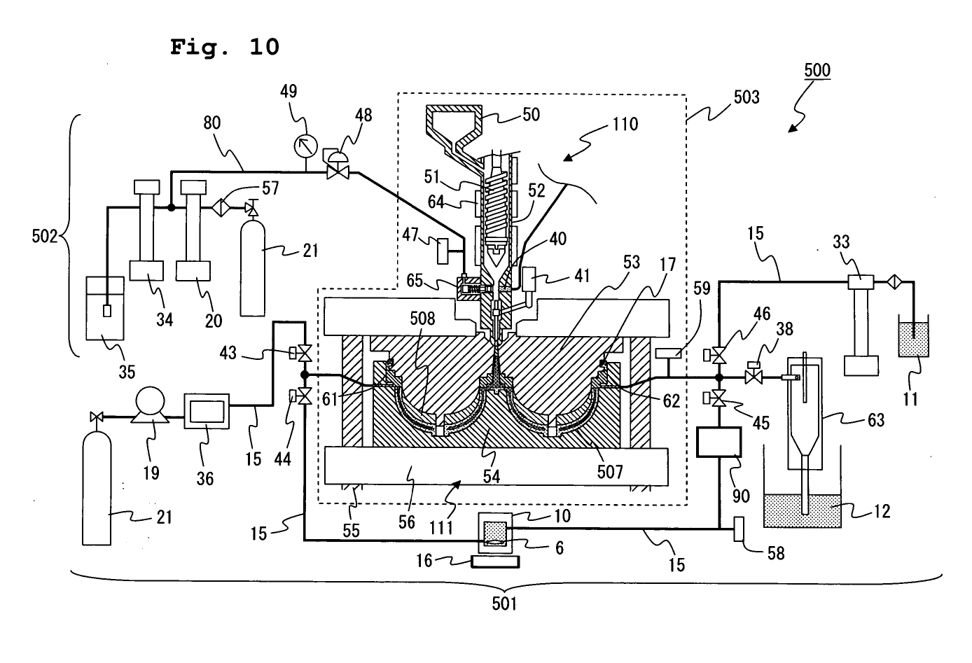

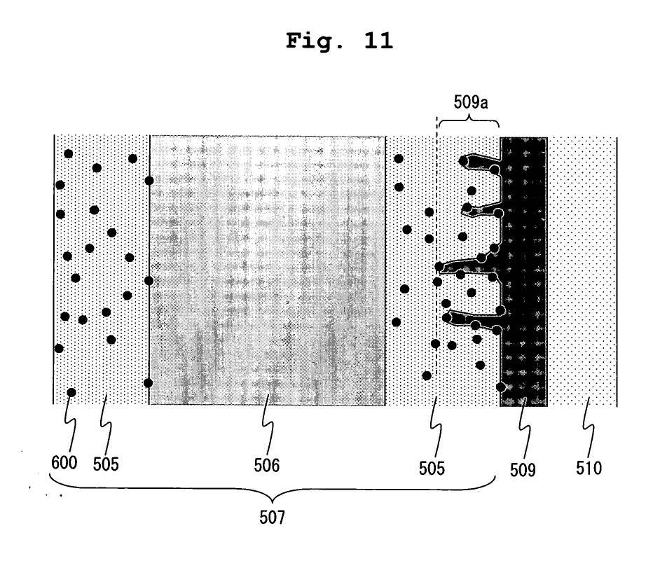

First, as shown in FIG. 10, the hydraulic clamp mechanism (not shown) of the clamp device 111 was moved back (in the lower direction in FIG. 10) to thereby move back the movable platen 56 and the movable mold 54 while the molded polymer substrate 507 was held in the mold, so that a gap 508 (cavity 508) was formed between the fixed mold 53 and the polymer substrate 507.

Next, the pressure of the carbon dioxide supplied from the carbon dioxide cylinder 21 of the electroless plating apparatus part 501 was increased by the pump 19 and the carbon dioxide was stored in the buffer tank 36. Next, the automatic valve 43 was opened to introduce the pressurized carbon dioxide stored in the buffer tank 36 to the cavity 508 via the plating solution inlet channel 61 and the pressurized carbon dioxide was brought into contact with a surface of the polymer substrate 507 (Step S62 in FIG. 13). At this time, since the cavity 508 is sealed by the engagement between the spring-equipped seal 17 provided in the outside diameter portion of the fixed mold 13 and the movable mold 54, the introduced pressurized carbon dioxide does not leak to the outside of the mold. Further, at this time, the pressure of the pressurized carbon dioxide in the cavity 508 was set to 15 MPa. Such contact of the pressurized carbon dioxide with the surface of the polymer substrate 507 causes the swelling of the surface of the polymer substrate 507, which can provide an effect that a subsequently introduced mixed fluid of the pressurized carbon dioxide and the electroless plating solution smoothly permeates into the inside of the polymer substrate 507.

Next, in the following manner, the electroless plating solution containing the pressurized carbon dioxide was introduced into the cavity 508 to be brought into contact with the polymer substrate 507. First, in the high-pressure container 10, the electroless plating solution containing alcohol and a surfactant, which was supplied from the plating tank 11 of the electroless plating apparatus part 501, was mixed in advance with the pressurized carbon dioxide at 15 MPa supplied from the buffer tank 36. The electroless plating solution of this embodiment was prepared so that a ratio of the components contained therein became the same as that of the embodiment 1. Further, at this time, a stirrer 16 was driven and a magnetic stirrer 17 was rotated at high speed, thereby mixing the pressurized carbon dioxide and the electroless plating solution with each other in the high-pressure container 10. Next, the automatic valve 43 was closed and the automatic valves 44, 45 were opened.

Next, by the operation of the circulation pump 90, the electroless plating solution containing the pressurized carbon dioxide was circulated in a circulation channel composed of the high-pressure container 10, the pipe 15, and the cavity 508 to be brought into contact with the surface of the polymer substrate 507, thereby forming a plating film (nickel-phosphorus film) (Step S63 in FIG. 13). At this time, since the surface of the polymer molded article 507 is swollen, the electroless plating solution permeates into the inside of the polymer substrate 507 from the surface of the polymer substrate 507 and the plating film grows from the metallic fine particles dispersed in the inside of the polymer substrate 507 serving as catalyst cores. That is, in a state that a part of the plating film formed on the polymer substrate 507 penetrates (in a state that the plating film formed on the polymer substrate 507 enters the inside of the polymer substrate 507), the plating film grows, and consequently, the plating film with excellent adhesion is formed. In addition, during the electroless plating solution containing the pressurized carbon dioxide was circulating, the pressures of the cavity 508 and the circulation line 15 measured by pressure sensors 58, 59 were equal to each other. Further, the supply of the electroless plating solution was performed as needed by such a manner that the plating solution supplied from the plating tank 11 was increased in pressure by the syringe pump 33 and was sent at the same time when the automatic valve 46 was opened.

Next, after the plating film was formed on the polymer substrate 507 by the above-described method, the electroless plating solution containing the pressurized carbon dioxide was discharged to the collection tank 12 via the collection container 63 from the circulation channel of the electroless plating solution containing the pressurized carbon dioxide. Concretely, the automatic valves 44, 45 were closed and subsequently the automatic valve 38 was opened, thereby discharging the electroless plating solution containing the pressurized carbon dioxide to the collection container 63. In the collection container 63, the collected electroless plating solution containing the pressurized carbon dioxide is separated into a water solution (plating solution) and high-pressure gas (carbon dioxide) by the centrifugal separation principle. The plating solution is collected in the collection tank 12 to be usable again. The gasified carbon dioxide is discharged from the top of the collection container 63 to be collected in a not-shown exhaust duct.

Next, the automatic valve 43 was kept open for a predetermined time to introduce the pressurized carbon dioxide to the gap 508 (cavity 508) between the fixed mold 53 and the polymer substrate 507, and residues of the plating solution remained in the cavity 508 were discharged together with the pressurized carbon dioxide to the outside of the mold. Next, when a monitor value of the pressure sensor 59 indicated zero as the inner pressure of the cavity 508, the mold was opened and the polymer substrate 507 was taken out.

Next, typical substitutional gold plating was performed to the polymer substrate 507 which was taken out, to thereby laminating a gold plating film on the surface of the polymer substrate 507. In this embodiment, a polymer member in which the plating film was formed on the polymer substrate was obtained in the above-described manner.

A schematic cross-sectional diagram of a part of the polymer member manufactured in this embodiment is shown in FIG. 11. It was confirmed that metallic fine particles 600 (black circles in FIG. 11) were dispersed in the skin layer 505 of the polymer member manufactured in this embodiment (in this embodiment, the skin layer is the first area into which the metallic fine particles are impregnated). Further, on one side in the polymer substrate 507, a plating film 509 of nickel-phosphorus (metal film) grown in the mold was formed, and the plating film 509 of nickel-phosphorus grew from the inside of the polymer substrate 507 (a penetration layer 509a (second area) of the plating film 509 was formed). The penetration depth of the plating film of the polymer member manufactured in this embodiment into the polymer substrate 507 was about 200 nm, and at a position deeper than the penetration depth, Pd (metallic fine particles) 600 existed as shown in FIG. 11. Concretely, the depth of the skin layer (the first area into which Pd was impregnated) was about 100 μm. Further, a high reflection film 510 of gold was formed on the plating film 509 of nickel-phosphorus.

The same high-temperature high-humidity environmental test as in the embodiment 1 was conducted to the polymer member manufactured in this embodiment to evaluate adhesion of the metal film. Further, a high-temperature test was also conducted under the condition of 150° C. temperature and 500-hour standing time. As a result, the same result as that obtained in the embodiment 1 was obtained and no deterioration in adhesion of the metal film was observed. Further, surface roughness Ra of the polymer member manufactured in this embodiment was further measured. As a result, the surface roughness Ra was 100 nm, which is equivalent to the surface roughness of the mold. That is, it has been confirmed that, according to the method of manufacturing the polymer member of this embodiment, it is possible not only to perform the injection molding and the plating processing simultaneously to simplify processes but also to form a flat metal film with high adhesion on a highly heat-resistant resin material.

In the electroless plating processing of the above-described embodiment 6, the electroless plating solution was brought into contact with the polymer substrate after only the pressurized carbon dioxide was first brought into contact with the polymer substrate to swell the surface of the polymer substrate, but it should be noted that the present invention is not limited to this. For example, the plating film may be formed on the polymer substrate in such a manner that a first electroless plating solution containing pressurized carbon dioxide and having a plating solution concentration not causing a plating reaction is brought into contact with the polymer substrate, and subsequently a second electroless plating solution containing pressurized carbon dioxide and having a plating concentration causing the plating reaction is brought into contact with the polymer substrate. The plating solution concentration in this description means a concentration, in the plating solution, of a reducing agent such as sodium hypophosphite which is a factor determining the plating reaction. That is, to more concretely explain the above method, the electroless plating solution containing the reducing agent whose amount is small enough not to cause the plating reaction (first electroless plating solution) and the pressurized carbon dioxide may be brought into contact with the polymer substrate, thereby making the plating solution permeate into the polymer substrate, and then, the first electroless plating solution may be replaced with the electroless plating solution containing the reducing agent whose amount is large enough to cause the plating reaction (second electroless plating solution). Alternatively, the second electroless plating solution may be formed in such a manner that a solvent whose main component is the reducing agent and which contains water and/or alcohol and pressurized carbon dioxide are added to the first electroless plating solution containing a small amount of the reducing agent.

Further, the embodiment 6 has explained the embodiment that, at the time of the injection-molding of the polymer substrate, the metallic fine particles are impregnated on and inside the surface of the polymer substrate in such a manner that the metal complex is introduced into the flow front portion of the molten resin and then, the molten resin is injection-molded, but the present invention is not limited to this. The polymer substrate having the metallic fine particles impregnated on and inside the surface thereof may be molded by a sandwich molding method. Specifically, the polymer substrate may be molded by injecting molten resin containing the metallic fine particles from a heating cylinder and subsequently injecting molten resin not containing the metallic fine particles from another heating cylinder. Further, as in the embodiment, 1, the metallic fine particles may be impregnated on and inside the surface of the polymer substrate in such a manner that, after a polymer substrate having the metallic fine particles not impregnated on and inside the surface thereof is formed, pressurized carbon dioxide in which a metal complex is dissolved is brought into contact with the polymer substrate. Further, the embodiment 6 has explained the embodiment that the electroless plating is performed in the mold that the polymer substrate is molded, but the present invention is not limited to this. The molded polymer substrate may be held in a separately prepared mold to undergo the electroless plating therein.

### Embodiment 7

The embodiment 7 will explain a method in which, after a polymer substrate is injection-molded by using the same injection molding machine as used in the embodiment 6, electroless plating processing is performed in the same injection molding machine. In this embodiment, as in the embodiment 6, a reflector of an automobile headlight was manufactured as a polymer member and polyphenilene sulfide (FZ-8600 Black manufactured by Dainippon Ink and Chemicals, Incorporated) was used as a material forming the polymer substrate. In addition, a metal complex (hexafluoroacetylacetonato palladium (II)) was used as a raw material of the metallic fine particles.

In this embodiment, polyethylene glycol (substance soluble in an electroless plating solution: dissolution substance), whose average molecular weight is 1000, as a water soluble substance and the metallic fine particles are introduced to an apical portion (flow front portion) of molten resin platicized and measured in the platicizing cylinder (heating cylinder) to impregnate on and inside the surface of the polymer substrate. Specifically, the metal complex and the polyethylene glycol were dissolved in ethanol in the dissolver 35, and a mixed pressurized fluid in which the ethanol containing the dissolved metal complex and polyethylene glycol was mixed with the pressurized carbon dioxide was introduced to the apical portion (flow front portion) of the molten resin. Except for this, the polymer member of this embodiment was manufactured in the same manner as in the embodiment 6.

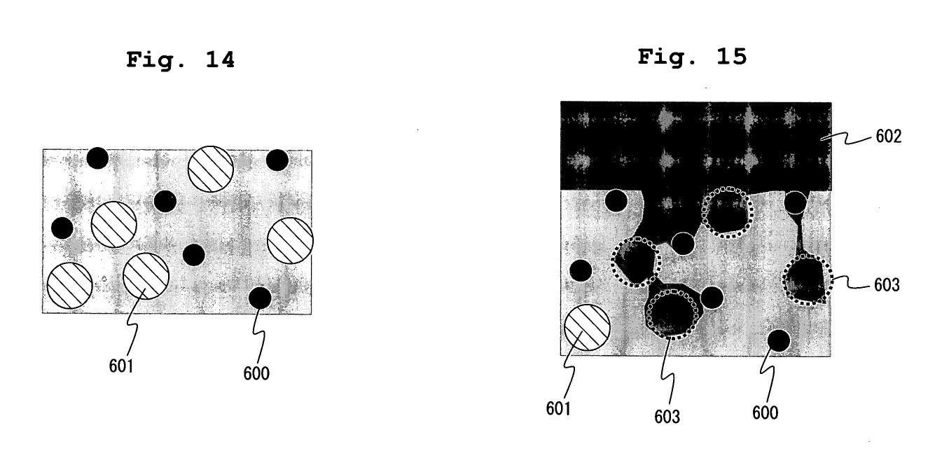

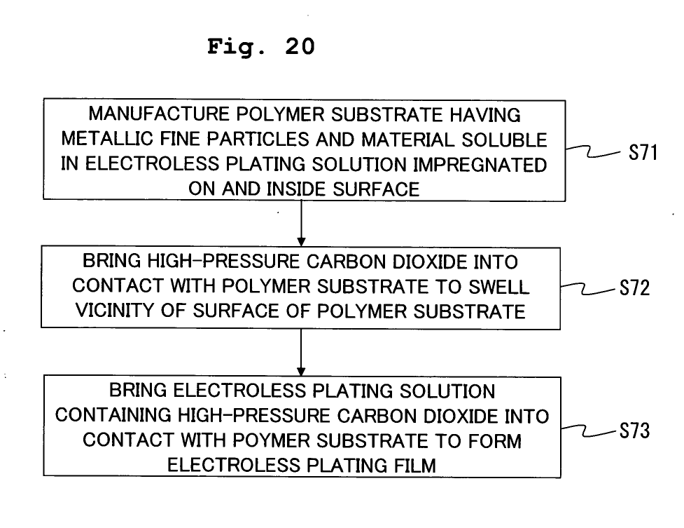

In this embodiment, the metal complex and the polyethylene glycol were introduced to the flow front portion of the molten resin in the platicizing cylinder 52 and the polymer substrate was injection-molded, and therefore, the polymer substrate can be obtained that the metallic fine particles and the polyethylene glycol are impregnated in the skin layer (on and inside the surface) thereof and are not substantially impregnated in the core layer thereof (Step S71 in FIG. 20). This state is shown in FIG. 14, and FIG. 14 is a schematic cross-sectional diagram of the vicinity of the surface (part of the skin layer) of the polymer substrate molded in this embodiment. In the vicinity of the surface of the polymer substrate of this embodiment immediately after it is molded, the metallic fine particles 600 and the polyethylene glycol 601 are dispersed as shown in FIG. 14. Particle size of the polyethylene glycol 601 impregnating in the inside of the polymer substrate molded in this embodiment, which was examined by an EPMA (Electron Probe Micro Analyzer), was about 50 nm.

Next, an electroless plating solution containing pressurized carbon dioxide was brought into contact with the polymer substrate in which the metallic fine particles 600 and the polyethylene glycol 601 were impregnated in the skin layer as shown in FIG. 14, in the same manner as in the embodiment 6, thereby forming a plating film on the polymer substrate (Steps S72 and S73 in FIG. 20).

When the electroless plating solution containing the pressurized carbon dioxide is brought into contact with the surface of the polymer substrate whose surface is swollen, the electroless plating solution permeates into the polymer substrate to reach the polyethylene glycol 601. At this time, since the polyethylene glycol 601 is a water soluble substance, the polyethylene glycol 601 dissolved in water and/or alcohol which are main components of the electroless plating solution, and the electroless plating solution enters areas which the polyethylene glycol 601 has occupied (where the polyethylene glycol 601 has existed) (the areas occupied by the polyethylene glycol 601 is replaced with the electroless plating solution). As a result, the electroless plating film grows also in the areas which have been occupied by the polyethylene glycol 601 (areas replaced with the electroless plating solution). As described above, in this embodiment, since the plating film can be grown in the areas where the polyethylene glycol 601 has existed, even in a case that a crystalline material with which a free volume in the polymer is difficult to increase is used as a material forming the polymer substrate, areas for the growth of the electroless plating film can be easily secured in the inside of the polymer substrate.

FIG. 15 shows a state of an interface between the polymer substrate and the plating film in a case that the plating film is formed on the polymer substrate by the manufacturing method of this embodiment. In this embodiment, since the plating film grows not only around the metallic fine particles 600 impregnating into the polymer substrate but also in the areas where the polyethylene glycol 601 has existed (areas surrounded by the broken lines 603 in FIG. 15), a plating film 602 having a very complicated shape grows in the inside of the polymer substrate as shown in FIG. 15, and thus the plating film continuing from the inside of the polymer substrate can be formed on the polymer substrate. Therefore, the plating film having higher adhesion is formed. In addition, as shown in FIG. 15, in the areas of the polyethylene glycol 601 not reached by the electroless plating solution, the polyethylene glycol 601 remain in the polymer substrate as they are without the polyethylene glycol 601 is dissolved therefrom.

A high-temperature and high-humidity environmental test similar to that of the embodiment 1 was conducted on the polymer member manufactured in this embodiment to evaluate adhesion of the metal film. A high-temperature test was also conducted under the condition of 150° C. temperature and 500-hour standing time. As a result, the same result as that of the embodiment 1 was obtained and no deterioration in adhesion of the metal film was recognized. Further, the surface roughness Ra of the polymer member manufactured in this embodiment was measured. As a result, the surface roughness Ra was 100 nm, which is equivalent to the surface roughness of the mold. That is, it has been confirmed that, according to the method of forming the plating film of this embodiment, it is possible not only to perform the plating processing simultaneously with the injection molding to simplify processes, but also to form a flat metal film with high adhesion on a highly heat-resistant resin material.

Further, in the polymer member manufactured in this embodiment, the penetration depth of the plating film into the polymer substrate was about 200 nm, and the metallic fine particles (Pd) existed up to a deeper position, concretely, up to a depth position of about 100 μm.

This embodiment has explained the embodiment that polyethylene glycol was used as a water soluble substance in order to form sufficient growth areas of the plating film in the inside of the polymer substrate, but it should be noted that the present invention is not limited to this, and it may be also used mineral components such as magnesium oxide and calcium carbonate, starch, sodium alginate, polyvinyl alcohol, polyvinylmethylether, acrylic acid, and the like. Further, instead of the water soluble substance, a soluble low-molecular material may be used, for example, polyethyleneoxide, ε-caprolactam, alcohol (ethanol, propanol, butanol, or the like), ethylene glycol, polyacrylamide, polyvinylpyrrolidone, ethyl cellulose, acetyl cellulose, and the like.

### Embodiment 8

The embodiment 8 will explain a method in which, after a polymer substrate is injection-molded by using the same injection molding machine as that used in the embodiment 6, electroless plating processing is performed in the same injection molding machine. Embodiment 7 has explained the embodiment that the polyethylene glycol which is a water soluble substance is impregnated together with the metallic fine particles on and inside the surface of the polymer substrate to form the sufficient growth areas of the plating film in the inside of the polymer substrate, but the embodiment 8 will explain an embodiment that fine foamed cells (voids) are formed in the inside of the polymer substrate to form sufficient growth areas of the plating film in the inside of the polymer substrate. Except that the fine foamed cells are formed in the inside of the polymer substrate, the polymer substrate was formed and the plating film was formed on the polymer substrate in the same manner as in the embodiment 7.

In this embodiment, as in the embodiment 6, a reflector of an automobile headlight was manufactured as the polymer substrate, and as a material forming the polymer substrate, polyphenilene sulfide (FZ-8600 Black manufactured by Dainippon Ink and Chemicals, Incorporated) was also used. As a raw material of metallic fine particles, a metal complex (hexafluoroacetylacetonato palladium (II)) was used.

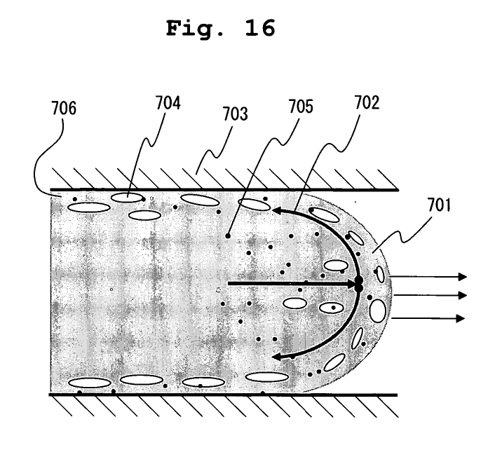

A method of forming the fine foamed cells in the inside of the polymer substrate in this embodiment will be explained with reference to FIGS. 16 to 19, 21, 22.

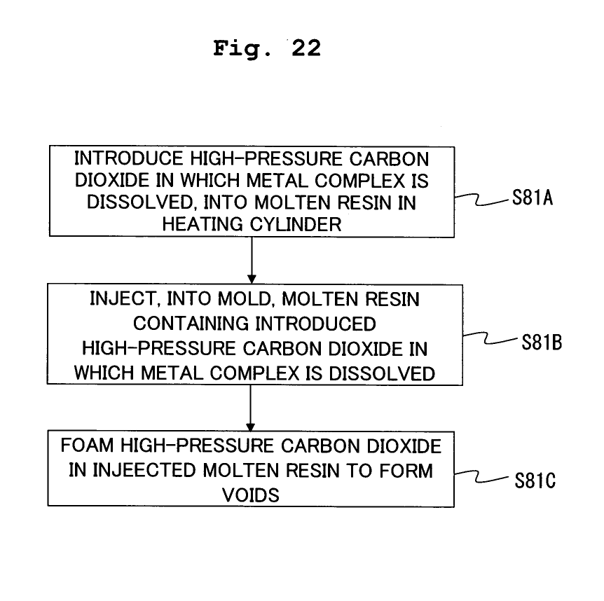

First, in the same manner as in the embodiment 7, pressurized carbon dioxide in which the metal complex (metallic fine particles) was dissolved was introduced to an apical portion (flow front portion) of molten resin platicized and measured in the platicizing cylinder (Step S81A in FIG. 22). Next, in the same manner as in the embodiment 7, the molten resin was injected to fill the cavity of the mold (Step S81B in FIG. 22). FIGS. 16 to 18 show states when the molten resin is injected and filled.

First, when the molten resin 701 at the flow front portion (metallic fine particles 705 and carbon dioxide are dispersed or dissolved therein) is filled in the cavity, the molten resin 701 is attracted to a mold wall surface 703 (exhibits the behavior shown by the arrow 702 in FIG. 16) by a fountain flow effect (fountain effect), to form a skin layer of the polymer substrate. Subsequently, molten resin containing neither the metallic fine particles 705 nor the carbon dioxide is filled to form a core layer of the polymer substrate.

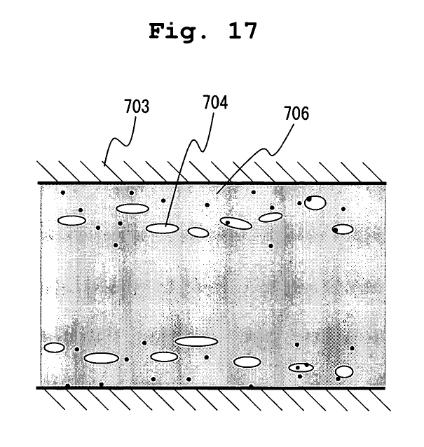

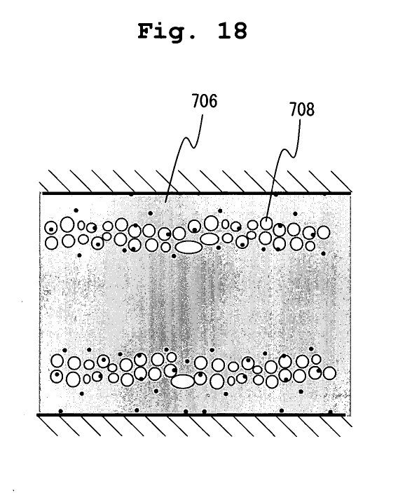

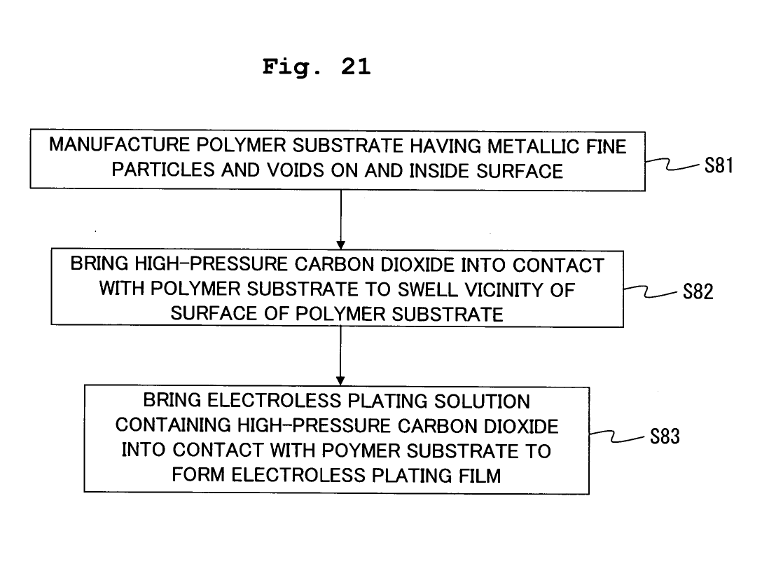

When the molten resin 701 at the flow front portion is filled, the carbon dioxide is reduced in pressure in a surface of the mold 703, thereby forming foamed cells 704, as shown in FIG. 16. As the filling further progresses, in a surface area 706 of the molten resin bringing in contact with the mold wall surface 703, almost all the clear foamed cells extinguish because the carbon dioxide is easily discharged in the surface area 706. It is thought that, as a result, the foamed cells 704 remain in an area on a slightly inner side of the surface area 706 of the polymer substrate, as shown in FIG. 17. Next, after the injection and filling, a clamp pressure of the mold was reduced with no dwell pressure applied, to rapidly reduce the inner pressure of the filled resin. As a result, as shown in FIG. 18, foamed cells 708 finer than the foamed cells 704 in FIG. 17 are formed in an area on the slightly inner side of the surface area 706 of the polymer substrate (on an inside of the polymer substrate) (Step S81C in FIG. 22). Next, in the same manner as in the embodiment 7, the polymer substrate was taken out from the mold. In this embodiment, the polymer substrate inside whose the fine foamed cells were formed was obtained in the above-described manner (Step S81 in FIG. 21). The size of each of the foamed cells 708 existing in the inside of the polymer substrate molded in this embodiment, which was measured by a SEM (Scanning Electron Microscope), was a size in a range of about 10 to 20 μm.

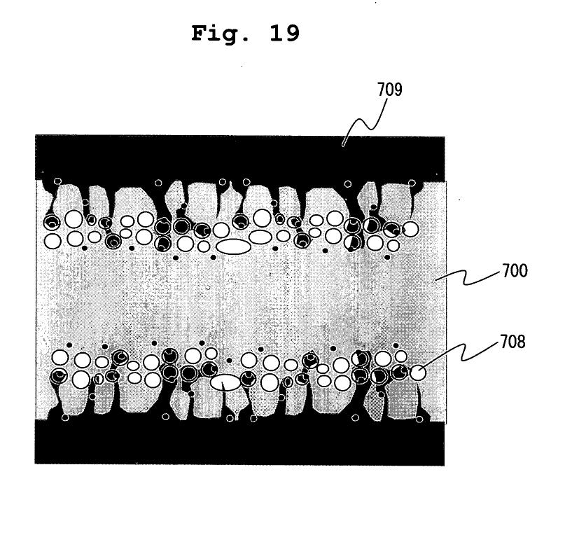

Next, in the same manner as in the embodiment 7, a mixed fluid of pressurized carbon dioxide and an electroless plating solution was brought into contact with the polymer substrate, thereby forming a plating film (Steps S82 and S83 in FIG. 21). At this time, the electroless plating solution permeates into the foamed cells 708 formed in the polymer substrate, and thus, the plating film also grows in the formed cells. As a result, as shown in FIG. 19, the plating film having a complicated shape grows deep inside the polymer substrate, and thus a plating film 709 continuing from the inside of the polymer substrate can be formed. Therefore, the plating film with higher adhesion is formed. In addition, as shown in FIG. 19, the foamed cells 708 not reached by the electroless plating solution remain as they are in the polymer substrate.

A high-temperature high-humidity environmental test as in the embodiment 1 was conducted on the polymer member manufactured in this embodiment to evaluate adhesion of the metal film. A high-temperature test was also conducted under the condition of 150° C. temperature and 500-hour standing time. As a result, the same result as that of the embodiment 1 was obtained, and no deterioration in adhesion of the metal film was recognized. That is, it has been confirmed that, according to the method of forming the plating film of this embodiment, it is possible not only to perform the plating processing simultaneously with the injection molding to simplify processes but also to form the metal film with high adhesion on a highly heat-resistant resin material.

Further, in the polymer member manufactured in this embodiment, the penetration depth of the plating film into the polymer substrate was about 50 μm, and the metallic fine particles (Pd) existed up to a deeper position, concretely, up to a depth position of about 100 μm.

The above embodiments 1 to 8 have explained the embodiments that the crystalline material is used as the material forming the polymer substrate (polymer molded article), but the present invention is not limited to this, and the same effect can be obtained also in a case that an amorphous material is used as the material forming the polymer substrate (polymer molded article).

The method of manufacturing the polymer member of the present invention does not require the roughening of the surface of the polymer substrate and can form a plating film growing continuously from the inside of the surface of the polymer substrate and therefore, is suitable as a method of forming a plating film excellent in adhesion on polymer substrates of various kinds.

Further, in a case that electroless plating processing is performed in an injection molding machine, the method of manufacturing the polymer member of the present invention can form a flat metal film with high adhesion on a highly heat-resistant resin material, and therefore is suitable as a method of manufacturing a reflector of an automobile headlight, such as a LED, requiring high heat resistance.

What is claimed is:

1. A method of manufacturing a polymer member, comprising:
preparing a polymer substrate having metallic fine particles impregnated on and inside a surface thereof;
bringing pressurized carbon dioxide into contact with the polymer substrate to swell a surface area of the polymer substrate; and
bringing an electroless plating solution containing the pressurized carbon dioxide into contact with the polymer substrate, in a state that the surface area of the polymer substrate is swollen, to form a plating film on the polymer substrate.

2. The method of manufacturing the polymer member according to claim 1, wherein, when the pressurized carbon dioxide is brought into contact with the polymer substrate, the electroless plating solution having a temperature not causing a plating reaction together with the pressurized carbon dioxide is brought into contact with the polymer substrate to be impregnated into the polymer substrate, and when the plating film is formed on the polymer substrate, the temperature of the electroless plating solution is increased to a temperature causing the plating reaction.

3. The method of manufacturing the polymer member according to claim 1, wherein the electroless plating solution contains alcohol.

4. The method of manufacturing the polymer member according to claim 1, wherein the electroless plating solution contains a surfactant.

5. The method of manufacturing the polymer member according to claim 1, wherein the pressurized carbon dioxide is supercritical carbon dioxide having a pressure in a range of 7.38 MPa to 20 MPa.

6. The method of manufacturing the polymer member according to claim 1, further comprising performing at least one of electroless plating and electrolytic plating at atmospheric pressure after forming the plating film on the polymer substrate.

7. The method of manufacturing the polymer member according to claim 1, further comprising performing black electroless plating after forming the plating film on the polymer substrate.

8. The method of manufacturing the polymer member according to claim 1, wherein the preparing of the polymer substrate having the metallic fine particles impregnated on and inside the surface thereof includes bringing a pressurized fluid, in which a metal complex containing the metallic fine particles is dissolved, into contact with the polymer substrate.

9. The method of manufacturing the polymer member according to claim 1, wherein the preparing of the polymer substrate having the metallic fine particles impregnated on and inside the surface thereof includes molding the polymer substrate, which has the metallic fine particles impregnated on and inside the surface thereof, in a mold of an injection molding machine.

10. The manufacturing method of the polymer member according to claim 1, wherein, when the plating film is formed on the polymer substrate, a high-pressure container made of metal and including, on an inner wall surface thereof, a film inert to the electroless plating solution is used, and in the high-pressure container, the polymer substrate is brought into contact with the electroless plating solution containing the pressurized carbon dioxide.

11. The method of manufacturing the polymer member according to claim 10, wherein the film is formed of diamond-like carbon.

12. The method of manufacturing the polymer member according to claim 1, wherein, when the plating film is formed on the polymer substrate, a plating apparatus is used, the plating apparatus including: a high-pressure container made of metal; and an inner container disposed in the high-pressure container and formed of a material inert to the electroless plating solution; and
in the inner container, the polymer substrate is brought into contact with the electroless plating solution containing the pressurized carbon dioxide.

13. The method of manufacturing the polymer member according to claim 12, wherein the inner container is formed of polytetrafluoroethylene.

14. The method of manufacturing the polymer member according to claim 1, wherein, when the polymer substrate is prepared, a polymer substrate having the metallic fine particles and particles of a substance soluble in the electroless plating impregnated on and inside the surface thereof is prepared.

15. The method of manufacturing the polymer member according to claim 14, wherein the preparing of the polymer substrate includes molding, in a mold of an injection molding machine, the polymer substrate having the metallic fine particles and the substance soluble in the electroless plating solution impregnated on and inside the surface thereof.

16. The method of manufacturing the polymer member according to claim 14, wherein the substance soluble in the electroless plating solution is a water soluble substance.

17. The method of manufacturing the polymer member according to claim 1, wherein, when the polymer substrate is prepared, a polymer substrate having the metallic fine particles and voids on and inside the surface thereof is prepared.

18. The method of manufacturing the polymer member according to claim 17, wherein the preparing of the polymer substrate having the metallic fine particles and the voids on and inside the surface thereof includes: introducing, by using an injection molding machine which includes a mold and a heating cylinder, the pressurized carbon dioxide, in which a metal complex containing the metallic fine particles is dissolved, into molten resin of the polymer substrate in the heating cylinder; injecting, into the mold, the molten resin containing the introduced pressurized carbon dioxide in which the metal complex is dissolved; and forming the voids by foaming the pressurized carbon dioxide in the injected molten resin.

19. A polymer member manufactured by the method of manufacturing the polymer member as defined in claim 14.

20. A polymer member manufactured by the method of manufacturing the polymer member as defined in claim 17.

21. A high-pressure container which is used in the method of manufacturing the polymer member as defined in claim 1 when the electroless plating solution is brought into contact with the polymer substrate, the high-pressure container comprising:
a high-pressure container body made of metal; and
a film formed on an inner wall surface of the high-pressure container body and formed of a material inert to the electroless plating solution.

22. The high-pressure container according to claim 21, wherein the film is formed of diamond-like carbon.

23. A plating apparatus used in the method of manufacturing the polymer member as defined in claim 1, the apparatus comprising:
a high-pressure container made of metal; and
an inner container disposed in the high-pressure container and used to bring the electroless plating solution into contact with the polymer substrate,
wherein the inner container is formed of a material inert to the electroless plating solution.

24. The plating apparatus according to claim 23, wherein the inner container is formed of polytetrafluoroethylene.

25. A polymer member comprising:
a polymer substrate having metallic fine particles impregnated into a first area from a surface thereof to a predetermined depth; and
a metal film formed on the surface of the polymer substrate,
wherein a part of the metal film penetrates into a second area from the surface of the polymer substrate to a depth smaller than the predetermined depth.

26. The polymer member according to claim 25, wherein particles of a substance soluble in the electroless plating solution exist in an inside of the polymer substrate.

27. The polymer member according to claim 26, wherein the substance soluble in the electroless plating solution is a water soluble material.

28. The polymer member according to claim 25, wherein voids exists in an inside of the polymer member.
